(19) United States
(12) Patent Application Publication
(10) Pub. No.: US 2023/0331321 A1
(43) Pub. Date: Oct. 19, 2023

(54) PIVOTING ASSEMBLY AND TRACK SYSTEM HAVING SAME

(71) Applicant: SOUCY INTERNATIONAL INC., Drummondville (CA)

(72) Inventors: Jeremie AUBIN-MARCHAND, St-Hugues (CA); David BARRY, Longueuil (CA); Gabriel CHANTAL, Saint-Jude (CA)

(21) Appl. No.: 18/135,845

(22) Filed: Apr. 18, 2023

Related U.S. Application Data
(60) Provisional application No. 63/332,456, filed on Apr. 19, 2022.

(51) Int. Cl. B62D 55/15; B62D 55/084

(52) U.S. Cl. CPC B62D 55/15; B62D 55/084

(57) ABSTRACT

A pivoting assembly for connecting a support wheel assembly to a frame of a track system is disclosed. The pivoting assembly includes first, intermediate and second clamping members, first and second resilient members and a shaft configured to connect to the support wheel assembly. The first resilient member has first and second engaging portions configured to, respectively, operationally engage with the first clamping member, and a first engaging side of the intermediate clamping member. The second resilient member has third and fourth engaging portions configured to, respectively, operationally engage with a second engaging side of the intermediate clamping member and the second clamping member. The intermediate clamping member is 216apivotable about a pivot axis. The first and intermediate clamping members apply a first clamping force to the first resilient member. The intermediate and second clamping members apply a second clamping force to the second resilient member.

### CROSS-REFERENCE TO RELATED APPLICATION

The present application claims priority to U.S. Provisional Patent Application No. 63/332,456, filed Apr. 19, 2022 entitled “Pivoting Assembly and Track System Having Same”, which is incorporated by reference herein in its entirety.

### TECHNICAL FIELD

The present application generally relates to pivoting assemblies for track systems, and track systems having pivoting assemblies.

### BACKGROUND

Certain vehicles, such as, for example, agricultural vehicles (e.g., harvesters, combines, tractors, etc.), construction vehicles (e.g., trucks, front-end loaders, etc.) and recreational vehicles (e.g., all-terrain vehicles, utility-terrain vehicles, side-by-side vehicles, etc.) are used on ground surfaces that are soft, slippery and/or uneven (e.g., soil, mud, sand, ice, snow, etc.).

Conventionally, such vehicles have had large wheels with tires on them to move the vehicle along the ground surface. Under certain conditions, such tires may have poor traction on some kinds of ground surfaces and, as these vehicles are generally heavy, the tires may compact the ground surface in an undesirable way owing to the weight of the vehicle. For example, when the vehicle is an agricultural vehicle, the tires may compact the soil in such a way as to undesirably inhibit the growth of crops. When the vehicle is a recreational vehicle, the tires may lack traction on certain terrain and in certain conditions.

In order to reduce the aforementioned drawbacks, to increase traction and to distribute the weight of the vehicle over a larger area on the ground surface, track systems were developed to be used in place of at least some of the wheels and tires on the vehicles. For example, under certain conditions, track systems enable agricultural vehicles to be used in wet field conditions as opposed to its wheeled counterpart. In other conditions, track systems enable recreational vehicles to be used in low traction terrains such as snowy roads.

Conventional track systems do, however, present some inconveniences. When conventional track systems travel over laterally uneven surfaces, wheels can come into contact with drive lugs, which can result in premature wear of the drive lugs of the track, and/or sometimes result in detracking of the track system. Travelling over laterally uneven surface with conventional track systems can also lead to uneven load distribution across the track, which can result in premature wear of the track of the track system.

Some track systems include pivoting assemblies. These pivoting assemblies can be expensive to manufacture. These pivoting assemblies can also be expensive and/or difficult to replace.

Therefore, there is desire for a track system that could mitigate the above-mentioned issues.

### SUMMARY

It is an object of the present technology to ameliorate at least some of the inconveniences present in the prior art.

According to one aspect of the present technology, there is provided a pivoting assembly for connecting at least one support wheel assembly to a frame of a track system. The pivoting assembly includes first and second clamping members, an intermediate clamping member, first and second resilient members, and a shaft. The first resilient member has a first engaging portion operationally engaged with the first clamping member, and a second engaging portion. The intermediate clamping member has a first engaging side operationally engaged with the second engaging portion of the first resilient member, and a second engaging side. The intermediate clamping member is pivotable about the pivot axis. The shaft is connected to the intermediate clamping member and is configured to connect to at least one wheel assembly. The second resilient member has a third engaging portion and a fourth engaging portion, the third engaging portion being configured to operationally engage with the second engaging side of the intermediate clamping member. The second clamping member is operationally engaged with the fourth engaging portion of the second resilient member, and is connected to the first clamping member. The first clamping member and the intermediate clamping member are spaced to apply a first clamping force to the first resilient member. The second clamping member and the intermediate clamping member are spaced to apply a second clamping force to the second resilient member.

In some embodiments, in response to the intermediate clamping member pivoting about the pivot axis, at least one of the first and second resilient members are configured to bias the intermediate clamping member toward a first position.

In some embodiments, in a first state, when the first and intermediate clamping members apply the first clamping force, and the intermediate and second clamping members apply the second clamping force, the first engaging side of the intermediate clamping member engages the second engaging portion with a first contact area, and the second engaging side of the intermediate clamping member engages the third engaging portion with a second contact area. In a second state, the first and intermediate clamping members apply a third clamping force, the third clamping force being greater than the first clamping force, and the intermediate and second clamping members apply a fourth clamping force, the fourth clamping force being greater than the second clamping force, the first engaging side of the intermediate clamping member engages the second engaging portion with a third contact area, and the second engaging side of the intermediate clamping member engages the third engaging portion with a fourth contact area.

In some embodiments, the third contact area is greater than the first contact area and the fourth contact area is greater than the second contact area.

In some embodiments, the second contact area is configured to increase progressively in response to gradually increasing the first clamping force; and the fourth contact area is configured to increase progressively in response to gradually increasing the second clamping force.

In some embodiments, at least one of the first, second, third and fourth engaging portions has at least one inter-engageable member.

In some embodiments, the at least one inter-engageable member is a first inter-engageable member, and a corresponding one of the first clamping member, the second clamping member, the first side of the intermediate clamping member and the second side of the intermediate clamping member of the at least one of the first, second, third and fourth engaging portions has a second inter-engageable member complementary to the first inter-engageable member, the first inter-engageable member being configured to provide a mechanical interlock.

In some embodiments, at least one of the first and fourth engaging portions define a generally convex profile.

In some embodiments, at least one of a profile of a side extending between the first and second engaging portions of the first resilient member is generally concave, and a profile of a side extending between the first and second engaging portions of the second resilient member is generally concave.

In some embodiments, at least one of the second and third engaging portions define a generally concave profile.

In some embodiments, the intermediate clamping member is pivotable about the pivot axis by about 15 degrees.

In some embodiments, the first resilient member is disposed vertically above the intermediate clamping member and the second resilient member is disposed vertically below the intermediate clamping member.

In some embodiments, the first and second resilient members are made of a polymeric material.

In some embodiments, the polymeric material is rubber.

In some embodiments, the first clamping force pre-stresses the first resilient member; and the second clamping force pre-stresses the second resilient member.

In some embodiments, the first clamping member is a member of a frame of the track system.

In some embodiments, at least one of the first resilient member is a first leading resilient member, and the pivoting assembly further includes a second trailing resilient member longitudinally spaced from the first leading resilient member, and the second resilient member is a second leading resilient member, and the pivoting assembly further includes a second trailing resilient member longitudinally spaced from the second leading resilient member.

In some embodiments, the first and second leading resilient members are disposed longitudinally forward from the shaft, and the first and second trailing resilient members are disposed longitudinally rearward from the shaft.

In some embodiments, the second clamping member is removably connected to the first clamping member.

In some embodiments, the shaft has an axis lying on a plane that is generally parallel to a plane of the longitudinal axis, in an initial position.

According to another aspect of the present technology there is provided a track system. The track system includes a frame assembly, a sprocket wheel assembly operatively connected to the frame assembly, at least one pivoting assembly according to the above aspect or according to the above aspect and one or more of the above embodiments removably connected to the frame assembly and a plurality of support wheel assemblies connected to the frame assembly by the at least one pivoting assembly.

According to another aspect of the present technology, there is provided a pivoting assembly for a track system, the pivoting assembly being configured to connect to at least one wheel, the pivoting assembly includes first and second resilient members, first and second clamping members, an intermediate clamping member and a shaft. The first resilient member has a body which is resiliently compressible. The first clamping member and the intermediate clamping member being configured to exert a first compressive force on the first resilient member. The second resilient member has a body which is resiliently compressible. The second clamping member and the intermediate clamping member being configured to exert a second compressive force on the second resilient member. The shaft member having end portions which are connectable to wheel assemblies of the track system and being moveable about a pivot axis in response to a vertical displacement of the wheels. The shaft member is connected to the intermediate clamping member such that responsive to movement of the shaft member, one or both of the first resilient member and the second resilient member are further deformed and exert a responsive force on the intermediate clamping member to counteract the movement of the shaft member.

In some embodiments, the first resilient member, the first clamping member and the intermediate clamping member are elongate and are stacked vertically with respect to one another.

In some embodiments, the shaft member extends generally transversely to the intermediate clamping member.

In some embodiments, the second resilient member is formed in two parts and the second clamping member is formed in two parts, the shaft member extending between the respective parts of the second resilient member and the second clamping member.

In the context of the present specification, unless expressly provided otherwise, the words “first”, “second”, “third”, etc. have been used as adjectives only for the purpose of allowing for distinction between the nouns that they modify from one another, and not for the purpose of describing any particular relationship between those nouns.

It must be noted that, as used in this specification and the appended claims, the singular form “a”, “an” and “the” include plural referents unless the context clearly dictates otherwise.

As used herein, the term “about” in the context of a given value or range refers to a value or range that is within 20%, preferably within 10%, and more preferably within 5% of the given value or range.

As used herein, the term “and/or” is to be taken as specific disclosure of each of the two specified features or components with or without the other. For example “A and/or B” is to be taken as specific disclosure of each of (i) A, (ii) B and (iii) A and B, just as if each is set out individually herein.

For purposes of the present application, terms related to spatial orientation when referring to a track system and components in relation to the track system, such as “vertical”, “horizontal”, “forwardly”, “rearwardly”, “left”, “right”, “above” and “below”, are as they would be understood by a driver of a vehicle to which the track system is connected, the driver sitting on the vehicle in an upright driving position, with the vehicle steered straight-ahead and being at rest on flat, level ground.

Implementations of the present technology each have at least one of the above-mentioned object and/or aspects, but do not necessarily have all of them. It should be understood that some aspects of the present technology that have resulted from attempting to attain the above-mentioned object may not satisfy this object and/or may satisfy other objects not specifically recited herein.

Additional and/or alternative features, aspects, and advantages of implementations of the present technology will become apparent from the following description, the accompanying drawings, and the appended claims.

### BRIEF DESCRIPTION OF THE DRAWINGS

For a better understanding of the present technology, as well as other aspects and further features thereof, reference is made to the following description which is to be used in conjunction with the accompanying drawings, where:

FIG. 1 is a perspective view taken from a top, front, right side of a track system having a support system according to an embodiment of the present technology;

FIG. 2 is a right side elevation view of the track system of FIG. 1;

FIG. 3 is a perspective cross-sectional view taken across line 3-3 of FIG. 2;

FIG. 4 is a perspective view taken from a top, front, left side of the pivoting assembly of the track system of FIG. 1;

FIG. 5 is a top plan view of the pivoting assembly of FIG. 4;

FIG. 6A is a cross-sectional view of the pivoting assembly of FIG. 4 taken along line 6A-6A of FIG. 5;

FIG. 6B is a cross-sectional view of the pivoting assembly of FIG. 4 taken along line 6B-6B of FIG. 5;

FIG. 6C is a perspective cross-sectional view of the pivoting assembly of FIG. 4 taken along line 6C-6C of FIG. 5;

FIG. 7A is a perspective view taken from a top, front, left side of the pivoting assembly of FIG. 4, with an upper clamping member being omitted;

FIG. 7B is a cross-sectional view of the pivoting assembly of FIG. 4 showing stresses within the upper and lower resilient members when a load is applied to the shaft;

FIG. 8A is an exploded perspective view taken from a front, top, left side of a pivoting assembly according to an alternative embodiment of the present technology;

FIG. 8B is an exploded perspective view taken from a front, bottom, left side of the pivoting assembly of FIG. 8A;

FIG. 9A is a cross-sectional view of the pivoting assembly of FIG. 8A with a shaft thereof being in an initial position;

FIG. 9B is a cross-sectional view of the pivoting assembly of FIG. 8A with a shaft thereof being pivoted from the initial position;

FIG. 10 is an exploded perspective view of a pivoting assembly according to an alternative embodiment of the present technology;

FIG. 11 is an exploded perspective view of a pivoting assembly according to an alternative embodiment of the present technology;

FIG. 12A is a cross-sectional view of the pivoting assembly of FIG. 11 with a shaft thereof being in an initial position;

FIG. 12B is a cross-sectional view of the pivoting assembly of FIG. 11 with a shaft thereof being pivoted from the initial position;

FIG. 13 is an exploded perspective view of a pivoting assembly according to an alternative embodiment of the present technology; and

FIG. 14 is a cross-sectional perspective view of a pivoting assembly according to an alternative embodiment of the present technology;

### DETAILED DESCRIPTION

The present disclosure is not limited in its application to the details of construction and the arrangement of components set forth in the following description or illustrated in the drawings. The disclosure is capable of other embodiments and of being practiced or of being carried out in various ways. Also, the phraseology and terminology used herein is for the purpose of description and should not be regarded as limiting. The use of “including”, “comprising”, or “having”, “containing”, “involving” and variations thereof herein, is meant to encompass the items listed thereafter as well as, optionally, additional items. In the following description, the same numerical references refer to similar elements.

The present technology relates to a pivoting assembly for a track system. The pivoting assembly is operatively connected to at least one wheel assembly of the track system and is configured to dampen vibrations in the track system, to assist the track system in overcoming obstacles, and to simplify maintenance of the track system.

The pivoting assembly includes resilient members that are resiliently deformable (compressible) and that, upon deformation, bias the pivoting assembly towards a first configuration, thereby urging the wheel assembly connected to the pivoting assembly from a displaced position towards a neutral position.

The pivoting assembly also includes clamping members which exert a clamping force on the resilient members, to pre-stress them, when the pivoting assembly is in the neutral position.

One of the clamping members (an intermediate clamping member) can move responsive to the vertical displacement of the wheels to thereby further compress the resilient members. The resilient nature of the resilient members exerts a force to counteract the movement of the intermediate clamping member to thereby cushion the vertical wheel movement. Due to the resilient members being pre-stressed, the biasing forces exerted thereby are increased and can help dampen vibrations.

### Track System

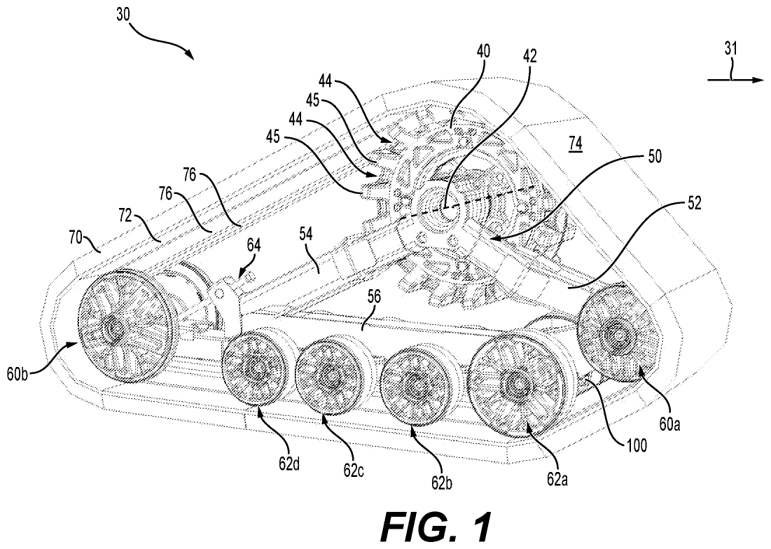

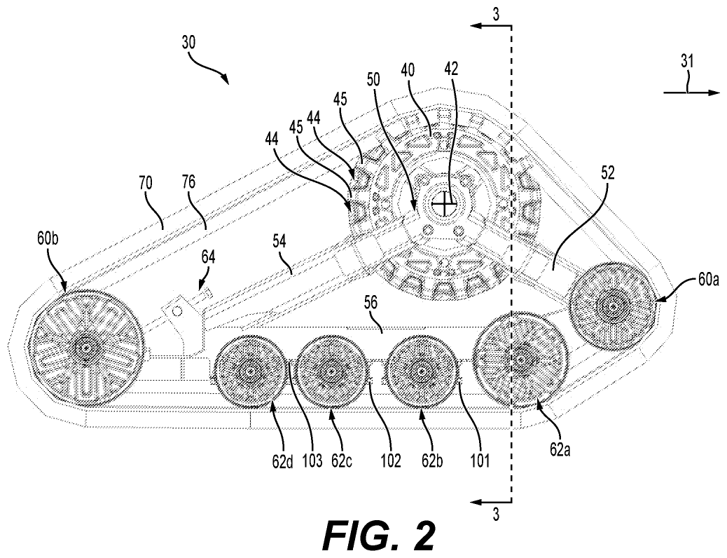

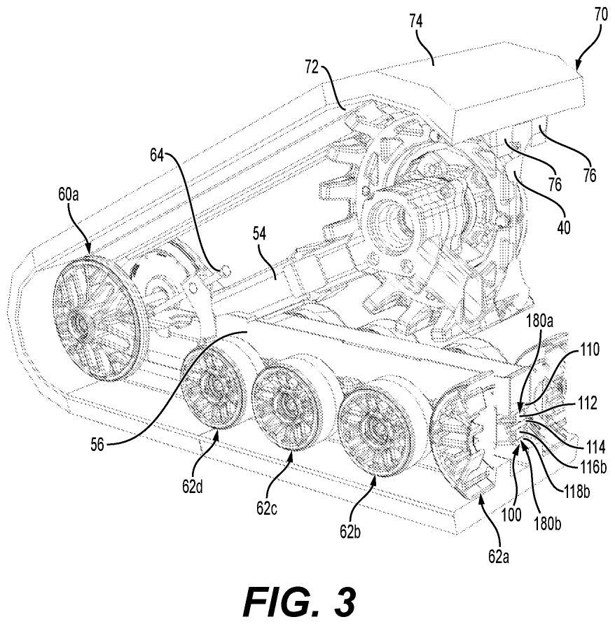

With reference to FIGS. 1 to 3, the present technology will be described with reference to a track system 30, the forward direction of which is indicated by arrow 31. The track system 30 is operatively connectable to a vehicle (not shown). Specifically, the track system 30 is operatively connectable to a shaft of the vehicle. In some embodiments, the vehicle is an agricultural vehicle such as a harvester, a combine or a tractor. In other embodiments, the vehicle is a construction vehicle such as a bulldozer, a skid-steer loader, an excavator or a compact track loader. In yet other embodiments, the vehicle is a recreational vehicle such as an all-terrain-vehicle, a side-by-side vehicle or a utility-terrain vehicle. It is further contemplated that the present technology could be used with industrial and military vehicles as well. It is also contemplated that the present technology could be used with trailers or other unpowered vehicles.

The track system 30 includes a sprocket wheel assembly 40 which can be operatively connected to the shaft (not shown) of the vehicle. The shaft is a driving shaft, but it is contemplated that in some embodiments, the sprocket wheel assembly 40 could be connected to a non-driving shaft. The driving shaft is configured to drive the sprocket wheel assembly 40 such that the sprocket wheel assembly 40 can rotate about a sprocket axis 42. The sprocket axis 42 is generally perpendicular to the forward direction of travel of the vehicle. The sprocket wheel assembly 40 has laterally extending engaging members 44 (i.e., teeth) disposed on the circumference of the sprocket wheel assembly 40. The sprocket wheel assembly 40 defines, between each of two engaging members 44, recesses 45. The engaging members 44 and the recesses 45 are adapted, as will be described in greater detail below, to engage with lugs 76 provided on an inner surface 72 of the endless track 70. It is contemplated that in other embodiments, the configuration of the sprocket wheel assembly 40 could differ without departing from the scope of the present technology.

The track system 30 further includes a frame 50. The frame 50 includes a leading frame member 52, a trailing frame member 54 and a lower frame member 56. The leading and trailing frame members 52, 54 are jointly connected around the driving shaft of the vehicle, the joint connection being positioned laterally outwardly from the sprocket wheel assembly 40. The leading frame member 52 extends forwardly and downwardly from the joint connection, and connects to a forward portion of the lower frame member 56. The trailing frame member 54 extends rearwardly and downwardly from the joint connection, and connects to a rearward portion of the lower frame member 56. The lower frame member 56, which is positioned below the joint connection, extends generally parallel to the forward direction 31 of travel of the track system 30. In the present embodiment, the leading, trailing and lower frame members 52, 54, 56 are integral. It is contemplated that in other embodiments, the leading, trailing and lower frame members 52, 54, 56 could be distinct members connected to one another. It is further contemplated that in some embodiments, the frame 50 could include more or less than three members. In some embodiments, one or more of the leading, trailing and lower frame members 52, 54, 56 could be pivotally connected to one another.

With continued reference to FIGS. 1 to 3, the track system 30 includes a leading idler wheel assembly 60a, a trailing idler wheel assembly 60b, and four support wheel assemblies 62a, 62b, 62c, 62d. Each of the leading and trailing idler wheel assemblies 60a, 60b and the support wheel assemblies 62a, 62b, 62c, 62d includes two laterally spaced wheels.

The leading idler wheel assembly 60a is rotationally connected to a leading end of the lower frame member 56.

The four support wheel assemblies 62a, 62b, 62c, 62d, which are disposed longitudinally rearwardly from the leading idler wheel assembly 60a, are connected to the lower frame member 56 by, respectively, pivoting assemblies 100, 101, 102, 103. The pivoting assemblies 100, 101, 102, 103 will be described in greater detail below. A diameter of the laterally spaced wheels of the support wheel assembly 62a is larger than a diameter of the laterally spaced wheels of the support wheel assemblies 62b, 62c, 62d. This can extend life of various components of the track system 30. It is contemplated that in some embodiments, the wheels of the four support wheel assemblies 62a, 62b, 62c, 62d could all have the same diameter.

The trailing idler wheel assembly 60b is connected to the lower frame member 56 via a tensioner 64. The tensioner 64 is operable to adjust the tension in the endless track 70 by selectively moving the trailing idler wheel assembly 60b toward or away from the frame 50. It is contemplated that in some embodiments, the tensioner 64 could be connected to the leading idler wheel assembly 60a instead of the trailing idler wheel assembly 60b. In some embodiments, the tensioner 64 could be omitted.

The track system 30 also includes the endless track 70, which extends around components of the track system 30, notably the frame 50, the leading and trailing idler wheel assemblies 60a, 60b, the support wheel assemblies 62a, 62b, 62c, 62d and the pivoting assemblies 100, 101, 102, 103. The endless track 70 has the inner surface 72 and an outer surface 74. The inner surface 72 of endless track 70 has the left and right sets of lugs 76. The left and right set of lugs 76 are adapted to engage within the engaging members 44 of the sprocket wheel assembly 40. It is contemplated that in some embodiments, there could be only one set of lugs 76. The outer surface 74 of the endless track 70 has a tread (not shown) defined thereon. It is contemplated that the tread could vary from one embodiment to another. In some embodiments, the tread could depend on the type of vehicle on which the track system 30 is to be used and/or the type of ground surface on which the vehicle is destined to travel. In the present embodiment, the endless track 70 is an endless polymeric track. It is contemplated that in some embodiments, the endless track 70 could be constructed of a wide variety of materials and structures.

### Pivoting Assembly According to a First Embodiment

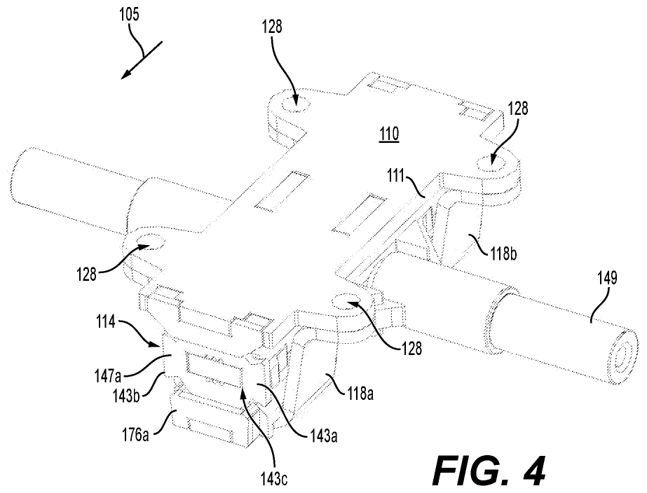

Referring to FIGS. 4, 5, 6A, 6B, 6C and 7A, the pivoting assemblies 100, 101, 102, 103 will now be described in greater. As the pivoting assemblies 100, 101, 102, 103 are similar, only the pivoting assembly 100, the forward direction of which is indicated by arrow 105, will be described in detail herewith.

The pivoting assembly 100 includes an upper clamping member 110, an upper resilient member 112, an intermediate clamping member 114, a lower resilient member 116 in two parts: leading and trailing lower resilient members 116a, 116b, and a lower clamping member 118 in two parts: leading and trailing lower clamping members 118a, 118b. It is contemplated that in some embodiments, the leading and trailing lower resilient members 116a, 116b could be a single lower resilient member, and that the leading and trailing lower clamping members 118a, 118b could be a single lower clamping member. A shaft 149 extends, transversely, from the intermediate clamping member 114 and is connected to the support wheel assembly 62a. The upper resilient member 112 is disposed between the upper and intermediate clamping members 110, 114, which apply an upper clamping force thereto, and the lower resilient member 116 is disposed between the intermediate and lower clamping members 114, 118, which apply a lower clamping force thereto. More specifically, as will be described below, the upper and intermediate clamping members 110, 114 form an upper capped enclosure 180a around the upper resilient member 112. As the lower resilient member 116 and the lower clamping member 118 are each respectively in two parts, the intermediate and leading lower clamping members 110, 118a form a leading lower capped enclosure 180b₁, and the intermediate and trailing lower clamping members 110, 118b form a leading lower capped enclosure 180b₂. As will also be described in greater detail below, the pivoting assembly 100 has an initial configuration, in which the shaft 149 is generally parallel to a ground surface upon which the track system 30 is resting. In response to vertical displacement of the support wheel assembly 62a, the shaft 149 will be displaced, which will cause deformation of the upper resilient member 112 and the leading and trailing lower resilient members 116a, 116b. Due to the resilient nature of the upper resilient member 112 and the leading and trailing lower resilient members 116a, 116b, a biasing force will be applied to the shaft 149 to move the pivoting assembly 100 toward the initial configuration.

The upper clamping member 110 is, in the present embodiment, a bottom part of the lower frame member 56, specifically a lower wall of the lower frame member 56. It is contemplated, however, that the upper clamping member 110 could be separate and distinct from the lower frame member 56. For example, the upper clamping member 110 could be fastened to the lower frame member 56.

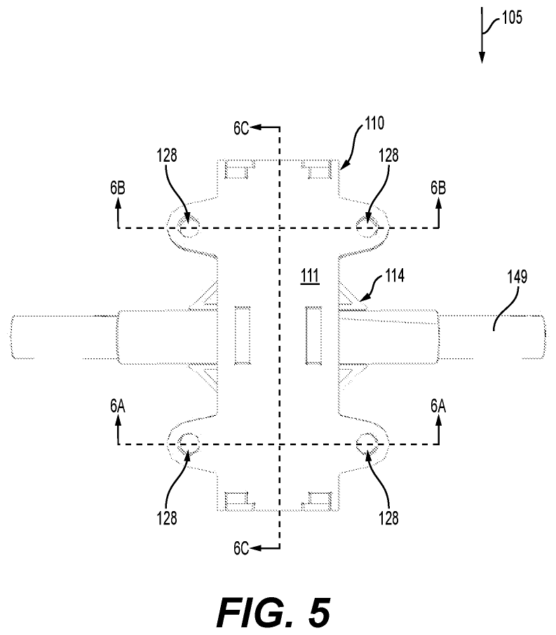

The upper clamping member 110 has a generally elongate body 111. The elongate body 111 has, on a bottom face thereof, a left border 120a and a right border 120b (FIG. 5). The left and right borders 120a, 120b are laterally spaced from one another, and extend longitudinally along the bottom face of the elongate body 111. The left and right borders 120a, 120b define therebetween an upper channel 122 that is configured to receive an upper part of the upper resilient member 112. It is contemplated that in some embodiments, the upper clamping member 110 could be made of one single piece, or could be made of two or more pieces connected to one another. For instance, the left and right borders 120a, 120b could be removably connected to the elongate body 111.

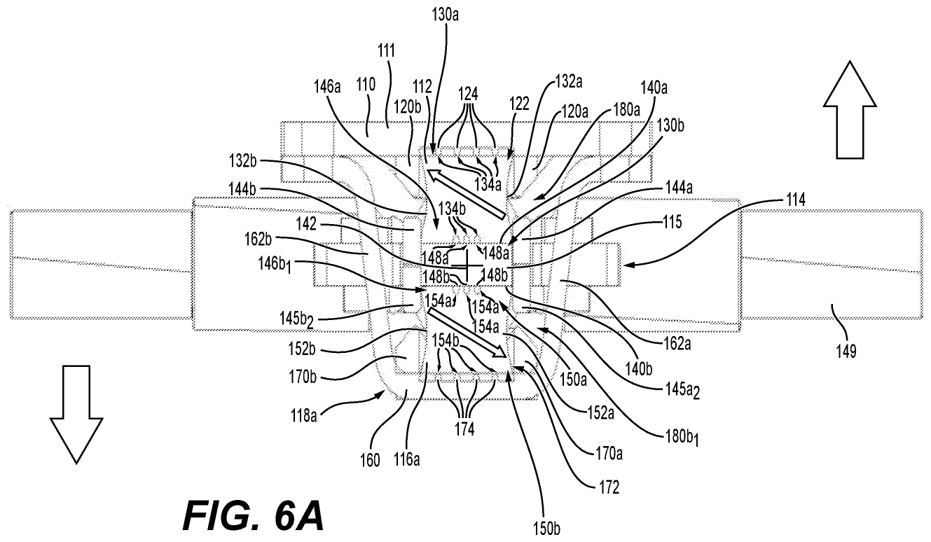

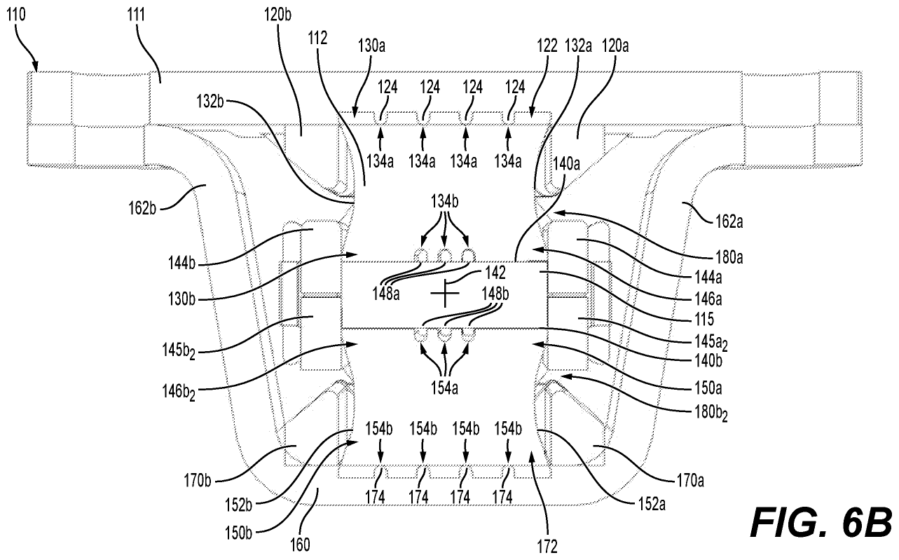

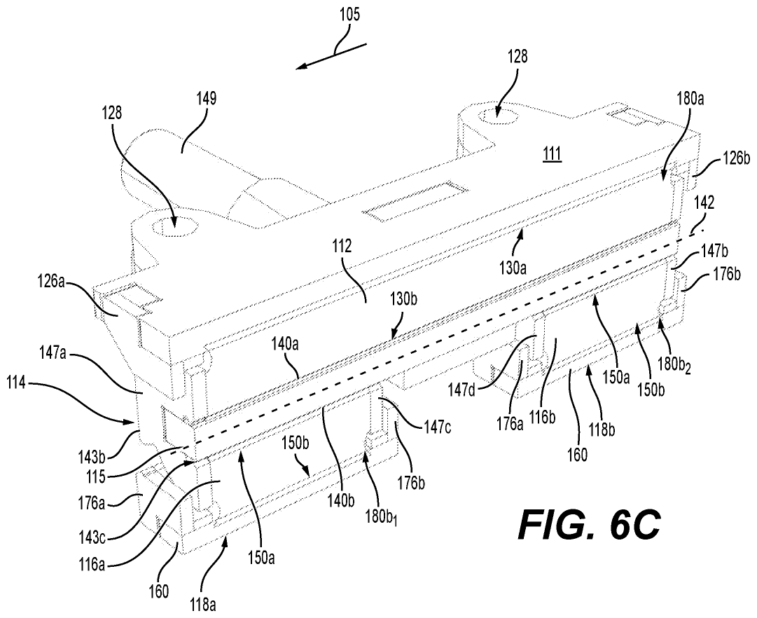

The upper clamping member 110 and an upper engaging portion 130a of the upper resilient member 112, have inter-engageable members. The upper clamping member 110 has, within the upper channel 122, inter-engageable members 124 (FIG. 6B). The inter-engageable member 124 are protrusions 124 which extend from the bottom face of the elongate body 111 into the upper channel 122. Like the left and right borders 120a, 120b, the protrusions 124 extend longitudinally along the elongate body 111. It is contemplated that the orientation of the protrusions 124 could be different from one embodiment to another.

The elongate body 111 defines four connecting apertures 128. The four connecting apertures 128 are positioned at each corner of the elongate body 111. More specifically, in the non-limiting illustrated embodiment, each of the connecting apertures 128 is defined in a tab positioned at a corner of the elongate body 111. It is contemplated that in other embodiments, there could be more or less than four connecting apertures. As will be described below, the connecting apertures 128 are configured to receive a fastener therein.

The upper clamping member 110 includes, on leading and trailing ends thereof, leading and trailing abutting portions 126a, 126b (best seen in FIG. 6C). In the present embodiment, the leading and trailing abutting portions 126a, 126b are connected to the elongate body 111. It is contemplated that in some embodiments, one or both of the leading and trailing abutting portions 126a, 126b could be formed as a single one piece with the elongate body 111, or could be removably connected thereto.

As will be described below, the leading abutting portion 126a is configured to abut with at least one of the upper resilient member 112 and a leading abutting portion 147a (described below) of the intermediate clamping member 114, and/or the trailing abutting portion 126b is configured to abut with at least one of the upper resilient member 112 and a trailing abutting portion 147b (described below) of the intermediate clamping member 114. The leading and trailing abutting portions 126a, 126b can assist in limiting longitudinal movement of the upper resilient member 112 relative to the upper clamping member 110. In other words, the leading and trailing abutting portions 126a, 126b can assist in retaining the upper resilient member 112 within the upper channel 122, and in some embodiments, guide a relative movement between the upper resilient member 112 and the upper clamping member 110. In some embodiments, the leading and/or trailing abutting portions 126a, 126b could be omitted.

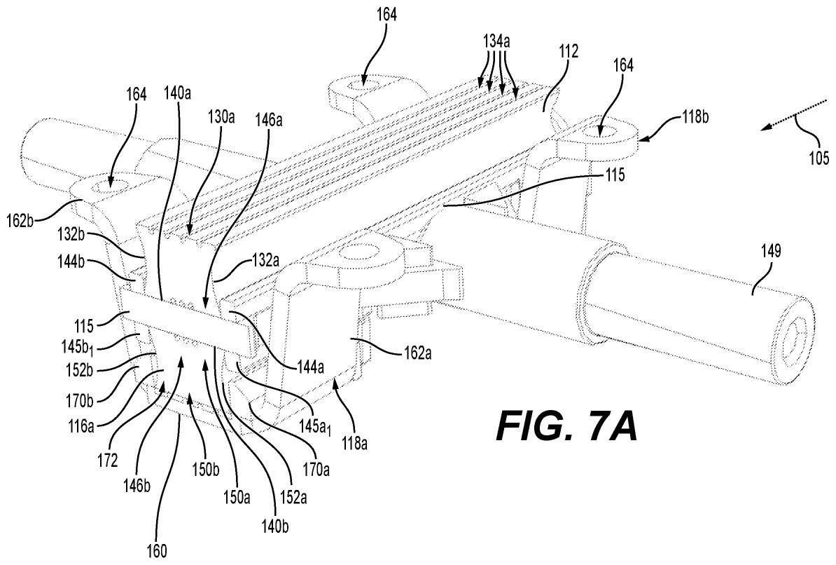

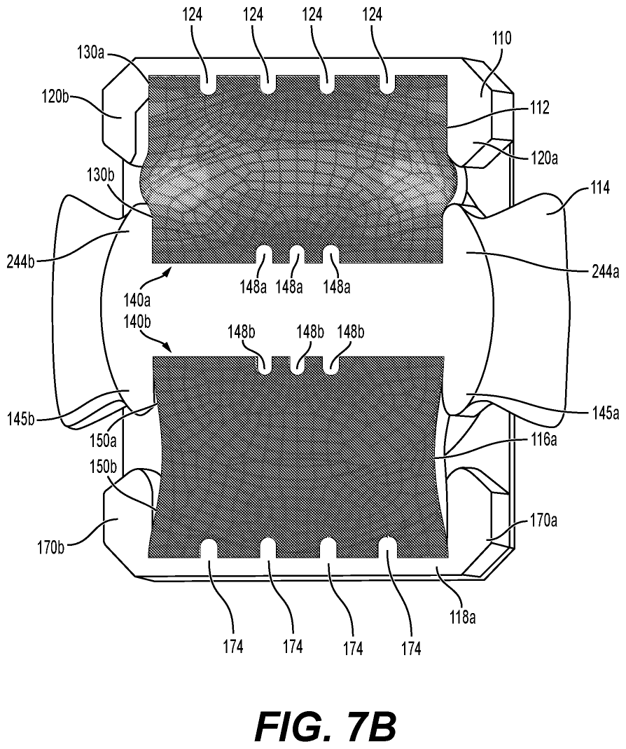

With continued reference to FIGS. 4, 5, 6A, 6B, 6C and 7A, the upper resilient member 112, which is generally elongate, has the upper engaging portion 130a, a lower engaging portion 130b, and lateral sides 132a, 132b. The upper resilient member 112 is waisted, in that a profile of the lateral sides 132a, 132b is concave (best seen in FIGS. 6B and 7A) when the pivoting assembly 100 is in the initial configuration. In response to the shaft 149 moving, the intermediate clamping member 114 moves relative to the upper clamping member 110 resulting in compressive and/or tensile forces being applied to at least some parts of the upper resilient member 112 (seen in FIG. 7B). In some instances, this can cause the profile of one or both of the lateral sides 132a, 132b of the upper resilient member 112 to resiliently change. For example, as shown in FIG. 7B, in portions undergoing compressive force (further to the upper clamping force), the profile of one or both of the lateral sides 132a, 132b may transform from being concave towards becoming linear or convex. It is contemplated that in some embodiments the lateral sides 132a, 132b could have linear profiles in the initial configuration. In other embodiments, one lateral side could be concave and the other side could be linear. In other embodiments, as will be described below, in the initial configuration, the lateral sides 132a, 132b, may have different profiles. For instance, the profile of the lateral sides 132a, 132b could be convex or linear.

The upper resilient member 112 is made of a polymeric material. In the present embodiment, the upper resilient member 112 is made of rubber. The upper resilient member 112 can be made of any elastic material that is able to elastically deform under compressive and/or tensile forces applied thereto due to movement of the shaft 149. More specifically, a distance between the upper clamping member 110 and the intermediate clamping member 114, when the pivoting assembly 100 is in the initial configuration, may be selected so as to pre-stress the upper resilient member 112 according to a predetermined amount. The predetermined amount may be selected such that the upper resilient member 112 can accommodate further compression and remain within the elastic limit of the upper resilient member 112.

The upper engaging portion 130a is configured to operationally engage the upper clamping member 110. More precisely, as will be described below, the upper engaging portion 130a is configured to be received in the upper channel 122.

The upper engaging portion 130a has inter-engageable members 134a. The inter-engageable members 134a are longitudinal slots 134a. The longitudinal slots 134a are complementary to the protrusions 124 of the upper clamping member 110, such that when the upper resilient member 112 and the upper clamping member 110 are connected, the protrusions 124 are received in the longitudinal slots 134a, thereby providing a mechanical interlock between the upper resilient member 112 and the upper clamping member 110. It is understood that in some embodiments, the upper resilient member 112 could have the protrusions, and the upper clamping member 110 could define the longitudinal slots, as long as there are inter-engageable portions between the upper resilient member 112 and the upper engaging portion 130a. In some embodiments, instead of extending longitudinally with respect to the upper clamping member 110, the protrusions 124 and the longitudinal slots 134a could extend differently, for example laterally or diagonally. Similarly, the lower engaging portion 130b defines longitudinal slots 134b. As will be described below, the longitudinal slots 134b are complementary to protrusions 148a (FIG. 5B) of the intermediate clamping member 114, thereby also providing mechanical interlock.

With continued reference to FIGS. 4, 5, 6A, 6B, 6C and 7A, the intermediate clamping member 114 comprises an elongate body 115, which has a top side 140a and a bottom side 140b. The intermediate clamping member 114 defines a longitudinal axis 142 (shown in FIG. 6C) that extends generally parallel to a longitudinal center plane of the pivoting assembly 200. The intermediate clamping member 114 is connected to the shaft 149. Since the intermediate clamping member 114 is, to a certain extent, not restricted from vertical movement (i.e., vertically moveable relative to the upper and lower clamping members 112, 118), the intermediate clamping member 114 is caused to move in response to a vertical movement of the wheel assembly 62a. As a result of the movement of the intermediate clamping member 114, the longitudinal axis 142 moves. Thus, in other words, the longitudinal axis 142 is a moveable virtual axis that is disposed between the upper and lower resilient members 112, 116a, 116b. The initial position of the intermediate clamping member 114, and thus the initial position of the longitudinal axis 142, is in part defined by the upper and lower resilient members 112, 116a, 116b. For instance, if the shaft 149 were to be caused to move vertically upwardly, the intermediate clamping member 114 would move vertically upwardly while the upper resilient member 112 is being resiliently compressed. Eventually, the left and right borders 120a, 120b of the upper clamping member 110 abut the left and right borders 144a, 144b of the intermediate clamping member 114, thereby stopping vertical movement of the shaft 149 and the intermediate clamping member 114. This abutment can assist in preventing plastic deformation of the upper resilient member 110.

The shaft 149 is disposed generally at a longitudinal center of the intermediate clamping member 114, and extends laterally (i.e., generally perpendicular to the longitudinal axis 142) away from the intermediate clamping member 114 in both directions. In the present embodiment, the shaft 149 is integral with the intermediate clamping member 114. In other embodiments, the shaft 149 could be removably connected to the intermediate clamping member 114. The shaft 149 is configured to rotationally or pivotally connect to the left and right wheels of the support wheel assembly 62a at, respectively, left and right ends of the shaft 149. In some embodiments, the shaft 149 could be configured to have a tandem wheel assembly connected thereto, instead of a single wheel. When the pivoting assembly 100 is in the initial configuration, the intermediate clamping member 114 defines an initial position (shown in FIGS. 4 and 5), in which the shaft 149 is generally perpendicular to the longitudinal center plane of the track system 30.

The elongate body 115 has, on the top side 140a, the left border 144a and the right border 144b. The left and right borders 144a, 144b, which are laterally spaced from one another, extend longitudinally along the top side 140a of the elongate body 115. The left and right borders 144a, 144b are generally parallel to one another, as well as to the left and right borders 120a, 120b. The left and right borders 144a, 144b define therebetween an upper intermediate channel 146a that is configured to receive a lower engaging portion 130b of the upper resilient member 112. As mentioned above, the intermediate clamping member 114 also has the protrusions 148a that extend into the upper channel 146a from the top side 140a of the elongate body 115, and that are positioned between the left and right borders 144a, 144b. The protrusions 148a are configured to be received in the longitudinal slots 134b of the lower engaging portion 130b of the upper resilient member 112.

Similarly, the elongate body 115 has, on the bottom side 140b, a leading left border 145a₁, a leading right border 145b₁, a trailing left border 145a₂ and a trailing right border 145b₂. The leading left and right borders 145a₁, 145b₁ are longitudinally spaced from the trailing left and right borders 145a₂, 145b₂ to accommodate for the shaft 149. The leading left and right borders 145a₁, 145b₁ which are laterally spaced from one another, extend longitudinally along the bottom side 140b of the elongate body 115. Similarly, the trailing left and right borders 145a₂, 145b₂ which are laterally spaced from one another, extend longitudinally along the bottom side 140b of the elongate body 115. In the present embodiment, the leading and trailing left borders 145a₁, 145a₂ are laterally aligned with the left border 144a, and the leading and trailing right borders 145b₁, 145b₂ are laterally aligned with the right border 144b. In other words, components below the intermediate clamping member 114 are not continuous but are in two parts with a spacing therebetween to accommodate the shaft 149. For example, unlike the upper resilient member 112 which is one-piece, the lower resilient member 116, as mentioned above, is in two parts: the leading lower resilient member part 116a and the trailing lower resilient member 116b. It is contemplated that in some embodiments, the leading and trailing left borders 145a₁, 145a₁ and the leading and trailing right borders 145b₁, 145b₂ could be connected, such that the lower resilient member 116 could be provided as a single component.

The leading left and right borders 145a₁, 145b₁ define therebetween a leading lower intermediate channel 146b₁ that is configured to at least partially receive an upper part of the leading lower resilient member 116a. Similarly, the trailing left and right borders 145a₂, 145b₂ define therebetween a trailing lower intermediate channel 146b₂that is configured to at least partially receive an upper part of the trailing lower resilient member 116b. The intermediate clamping member 114 has inter-engageable members 148b that extend into the leading and trailing lower intermediate channels 146b₁, 146b₂ from the bottom side 140b of the elongate body 115. The inter-engageable members 148b are longitudinal protrusions 148b, which are positioned between the leading left and right borders 145a₁, 145b₁ and between the trailing left and right borders 145a₂, 145b₂, and are configured to be received in longitudinal slots 154a defined in upper engaging portions 150a of the leading and trailing lower resilient members 116a,116b for providing a mechanical interlock.

Additionally, as best seen in FIG. 7A, the intermediate clamping member 114 also has the leading and trailing abutting portions 147a, 147b. The leading abutting portion 147a is connected to a front end of the elongate body 115, and the trailing abutting portion 147b is connected to a rear end of the elongate body 115. The leading and trailing abutting portions 147a, 147b, which extend beyond the top and bottom sides 140a, 140b, each have side wings 143a, 143b and define an aperture 143b configured to receive the elongate body 115 therein. Specifically, the leading and trailing abutting portions 147a, 147b are fixedly connected to the elongate body 115, such that when the elongate body 115 pivots, the leading and trailing abutting portions 147a, 147b also pivot, and when the elongate body 115 moves longitudinally, the leading and trailing abutting portions 147a, 147b also move longitudinally. As will be described below, the leading and trailing abutting portions 147a, 147b can limit the range of motion of the intermediate clamping member 114, notably the pivotal range of motion of the intermediate clamping member 114 about the longitudinal axis 142 and/or the longitudinal range of motion of the intermediate clamping member 114 relative to upper and lower clamping members 110, 118a, 118b.

Additionally, the intermediate clamping member 114 further includes a leading intermediate abutting portion 147c and a trailing intermediate abutting portion 147d connected to the elongate body 115. The leading and trailing intermediate abutting portions 147c, 147d extend downwardly from the bottom side 140b. The leading intermediate abutting portion 147c is proximate to, and generally perpendicular to, a rear end of the leading left and right borders 145a₁, 145b₁, whereas the trailing intermediate abutting portion 147d is proximate to, and generally perpendicular to, a front end of the trailing left and right borders 145a₂, 145b₂.

In some instances, such as during deformation of the upper resilient member 112 and/or the leading and trailing resilient members 116a, 116b, the leading abutting portion 147a can abut a front end of the upper resilient member 112, a front end of the leading lower resilient member 116a, the leading abutting portion 126a of the upper clamping member 110 and/or a leading abutting portion 176a of the leading lower clamping member 118a. Similarly, in some instances, the trailing abutting portion 147b can abut a rear end of the upper resilient member 112, a rear end of the trailing lower resilient member 116b, the trailing abutting portion 126b of the upper clamping member 110 and/or a trailing abutting portion 176b of the trailing lower clamping member 118b. Additionally, the leading intermediate abutting portion 147c can abut the rear end of the leading lower resilient member 116a and/or a trailing abutting portion 176b of the leading lower clamping member 118a, whereas the trailing intermediate abutting portion 147d can abut the front end of the trailing lower resilient member 116b and/or a leading abutting portion 176a of the trailing lower clamping member 118b. For example, responsive to a displacement of a wheel of the wheel assembly 62a, the intermediate clamping member 114 can move in a longitudinal direction such that the leading and trailing abutting portions 147a, 147b also move in the longitudinal direction, until the leading or trailing abutting portions 147a, 147b abut the corresponding one of the abutting portions 126a, 176a or the abutting portions 126b, 176b.

The engagement described in above can assist in keeping the upper resilient member 112 and/or the leading and trailing lower resilient members 116a, 116b in their respective capped enclosures 180a, 180b₁, 180b₂. In other words, the engagement can assist in keeping the upper resilient member 112 and/or the leading and trailing lower resilient members 116a, 116b from substantially moving in a direction longitudinal relative to the upper and lower clamping members 110, 118a, 118b.

It is contemplated that in some embodiments, the intermediate clamping member 114 could be made of one single piece, or could be made of two or more pieces connected to one another. For instance, the left and/or right borders 144a, 144b, 145a1, 145b1, 145a2, 145b2 could be removably connected to the elongate body 115.

Still referring to FIGS. 4, 5, 6A, 6B, 6C and 7A, the leading and trailing lower resilient members 116a, 116b will now be described in greater detail. The leading and trailing lower resilient members 116a, 116b are similar to one another, and are smaller versions of the upper resilient member 112.

The leading and trailing lower resilient members 116a, 116b are made of a polymeric material. In the present embodiment, the leading and trailing lower resilient members 116a, 116b are made of rubber. The leading and trailing lower resilient members 116a, 116b can be made of any elastic material that is able to elastically deform under compressive and/or tensile forces applied thereto due to movement of the shaft 149. More specifically, a distance between the leading lower clamping members 118a and the intermediate clamping member 114, and a distance between the trailing lower clamping members 118b and the intermediate clamping member 114, when the pivoting assembly 100 is in the initial configuration, may be selected so as to pre-stress the leading and trailing lower resilient members 116a, 116b according to a predetermined amount. The predetermined amount may be selected such that the leading and trailing lower resilient members 116a, 116b can accommodate further compression and remain within the elastic limit of the leading and trailing lower resilient members 116a, 116b.

The leading lower resilient member 116a is disposed longitudinally forward from the shaft 149 and is received in the leading lower intermediate channel 146b₁. The trailing lower resilient member 116b is disposed longitudinally rearward from the shaft 149 and is received in the trailing lower intermediate channel 146b₂. As the leading and trailing lower resilient members 116a, 116b are similar, only the leading lower resilient member 116a will be described herein.

The leading lower resilient member 116a, which is generally elongate, has the upper engaging portion 150a, a lower engaging portion 150b and lateral sides 152a, 152b. The lower resilient member 116a is waisted, in that a profile of the lateral sides 152a, 152b is concave when the pivoting assembly 100 is in the initial configuration. In response to the shaft 149 moving, the intermediate clamping member 114 moves relative to the lower clamping member 118a resulting in compressive and/or tensile forces being applied to at least some parts of the lower resilient member 116a. In some instances, this can cause the profile of one or both of the lateral sides 152a, 152 of the lower resilient member 116a to resiliently change. For example, in portions undergoing compressive force (further to the lower clamping force), the profile of one or both of the lateral sides 152a, 152b may transform from being concave towards becoming linear or convex. It is contemplated that in some embodiments the lateral sides 152a, 152b could have linear profiles in the initial configuration. In other embodiments, one lateral side could be concave and the other side could be linear. The upper engaging portion 150a is configured to operationally engage the bottom side 140b of the intermediate clamping member 114. More precisely, as will be described below, the upper engaging portion 150a is configured to be received in the leading lower intermediate channel 146b₁.

The upper engaging portion 150a defines longitudinal slots 154a. The longitudinal slots 154a are complementary to the protrusions 148b of the intermediate clamping member 114, such that when the leading lower resilient member 116a and the intermediate clamping member 114 are connected, the protrusions 148b are received in the longitudinal slots 154a, thereby providing a mechanical interlock between the leading lower resilient member 116a and the intermediate clamping member 114. It is understood that in some embodiments, the leading lower resilient member 116a could have the protrusions, and the intermediate clamping member 114 could define the longitudinal slots as long as there are inter-engageable portions between the leading lower resilient member 116a and the leading lower clamping member 118a. In some embodiments, the protrusions 148b and the longitudinal slots 154a could be oriented differently, for example laterally or diagonally. Similarly, the lower engaging portion 150b defines longitudinal slots 154b. As will be described below, the longitudinal slots 154b are complementary to protrusions 174 of the lower clamping member 118, thereby also providing mechanical interlock.

The leading and trailing lower clamping members 118a, 118b are configured to, respectively, engage with the leading and trailing lower resilient members 116a, 116b. As such, the leading lower clamping member 118a is disposed longitudinally forward from the shaft 149, whereas the trailing lower clamping member 118b is disposed longitudinally rearward from the shaft 149. As the leading and trailing lower clamping members 118a, 118b are similar, only the leading lower clamping member 118a will be described in detail herewith.

The leading lower clamping member 118a has a lower portion 160 and lateral portions 162a, 162b extending upwardly from the lower portion. Each one of the lateral portions 162a, 162b defines a connecting aperture 164 configured to receive fasteners therein. More specifically, upon assembly of the pivoting assembly 100, the connecting apertures 164 are aligned with two connecting apertures 128, and fasteners such as bolts and nuts (not shown) can be used to fasten the leading lower clamping member 118a to the upper clamping member 110. Thus, the leading lower clamping member 118a is removably connected to the upper clamping member 110. This selective connection enables an operator to easily access components of the pivoting assembly 100, which can be useful for maintenance purposes and/or to replace worn out components instead of having to replace the whole pivoting assembly 100.

Focusing on the lower portion 160, a left border 170a and a right border 170b extend upwardly from an upper surface of the lower portion 160. It is contemplated that in some embodiments, the leading lower clamping member 118a could be made of one single piece, or could be made of two or more pieces connected to one another. For instance, the left and right borders 170a, 170b could be removably connected to the lower portion 160. The left and right borders 170a, 170b are laterally spaced from one another, and extend longitudinally along the leading lower clamping member 118a. The left and right borders 170a, 170b define therebetween a lower channel 172 that is configured to at least partially receive part of the leading lower resilient member 116a. Specifically, the lower channel 172 is configured to receive the lower engaging portion 150b of the leading lower resilient member 116a. The leading lower clamping member 118a has, within the lower channel 172, inter-engageable members 174 (FIG. 6B). The inter-engageable members 174 are protrusions 174 which extend into the lower channel 172 from an upper surface of the leading lower clamping member 118a. Like the left and right borders 170a, 170b, the protrusions 174 extend longitudinally along the leading lower clamping member 118a. The leading lower clamping member 118a includes, on front and rear ends thereof, a leading abutting portion 176a and the trailing abutting portion 176b. In the present embodiment, the leading and trailing abutting portions 176a, 176b and the lower portion 160 are integral. It is contemplated that in some embodiments, the leading and trailing abutting portions 176a, 176b could be removably connected to the lower portion 160. As mentioned above, the leading and trailing abutting portions 176a, 176b are configured to abut with, respectively, the front and rear ends of the leading lower resilient member 116a. The leading and trailing abutting portions 176a, 176b are also configured to abut with, respectively, the leading abutting portion 147a and the leading intermediate abutting portion 147c, and are for keeping the leading lower resilient member 116a from moving longitudinally relative to the leading lower clamping member 118a.

Thus, the upper resilient member 112 is disposed between the upper clamping member 110 and the intermediate clamping member 114, the leading lower resilient member 116a is disposed between the intermediate clamping member 114 and the leading lower clamping member 118a and the trailing lower resilient member 116b is disposed between the intermediate clamping member 114 and the trailing lower clamping member 118b. More specifically, the upper engaging portion 130a of the upper resilient member 112 is received in the upper channel 122 of the upper clamping member 110 and the lower engaging portion 130b of the upper resilient member 112 is received in the upper intermediate channel 146a of the intermediate clamping member 114. The upper engaging portion 150a of the leading lower resilient member 116a is received in the leading lower intermediate channel 146b₁ of the intermediate clamping member 114, and the lower engaging portion 150b of the leading lower resilient member 116a is received in the lower channel 172 of the leading lower clamping member 118a. The upper engaging portion 150a of the trailing lower resilient member 116b is received in the trailing lower intermediate channel 146b₂ of the intermediate clamping member 114, and the lower engaging portion 150b of the trailing lower resilient member 116b is received in the lower channel 172 of the lower trailing clamping member 118b.

When the upper clamping member 110 is connected to the leading lower and trailing clamping members 118a, 118b (i.e., when the clamping members 110, 118a, 118b are clamped together), the upper clamping member 110 and the intermediate clamping member 114 form the upper capped enclosure 180a, and apply the upper clamping force to the upper resilient member 112, thereby inducing stresses within the upper resilient member 112. As such, the upper resilient member 112 is pre-stressed before undergoing any deformation in response to a movement of the intermediate clamping member 114 due to the support wheel assembly 62a moving. Similarly, the intermediate clamping member 114 and the leading lower clamping member 118a form a leading lower enclosure 180b₁, and apply a leading lower clamping force to the leading lower resilient member 116a, thereby inducing stresses within the leading lower resilient member 116a. Likewise, the trailing lower clamping member 118b and the intermediate clamping member 114 form a trailing lower enclosure 180b₂, and apply a trailing lower clamping force to the trailing lower resilient member 116b, thereby inducing stresses within the trailing lower resilient member 116b. Thus, the leading and trailing lower resilient members 116a, 116b are also pre-stressed before undergoing any deformation in response to a movement of the shaft 149 and the intermediate clamping member 114 due to the support wheel assembly 62a moving. The upper clamping force, the leading lower clamping force and the trailing lower clamping force can be the same or different.

In the present embodiment, pivoting assembly 100 is in the initial configuration when the upper clamping member 110 is connected to the leading and trailing lower clamping members 118a, 118b, and the shaft 149 is in a generally horizontal position. It is understood that when the pivoting assembly 100 is in the initial configuration, the components of the pivoting assembly 100 are in corresponding initial position. As best seen in FIGS. 6A and 6C, when the pivoting assembly 100 is in the initial configuration, there is a gap between the left and right borders 120a, 120b of the upper clamping member 110 and the left and right borders 144a, 144b of the intermediate clamping member 114. Similarly, there is also a gap between the left and right borders 170a, 170b of the leading and trailing lower clamping members 118a, 118b and the leading and trailing left and right borders 145a₁, 145b₁, 145a₂, 145b₂. These vertical gaps extend along the longitudinal axis 142 and can provide clearance for when the resilient members 112, 116a, 116b undergo deformation. In cases where the resilient members 112, 116a, 116b are deformed such that their sides bulge outwardly (e.g., the lateral sides 132a, 132b become convex), the gaps can accommodate the bulging.

In some embodiments, the connection between the upper clamping member 110 and the leading and trailing lower clamping members 118a, 118b is adjustable, which allows for adjustment of the respective clamping forces and the extent of pre-compression of the upper resilient member 112 and the leading and trailing lower resilient members 116a, 116b. It is contemplated that in some embodiments, the connection between the upper clamping member 110 and the leading and trailing lower clamping members 118a, 118b is such that the upper and/or lower resilient members 112, 116a, 116b, in the initial configuration, have a profile with an outward bulge (similar to the upper resilient member 112 shown in FIG. 7B).

Without being held to any theory, it is thought that pre-stressing the resilient members 112, 116a, 116b can reduce how much a resilient member resiliently deforms (extent of compression) compared to a non-stressed resilient member. The upper resilient member 112 and the leading and trailing lower resilient members 116a, 116b being pre-stressed can assist in dampening vibrations, and can assist in increasing biasing forces produced due to deformation.

When the track system 30 to which the pivoting assembly 100 is connected rests on a flat surface, a normal force is applied on the wheel assembly 62a, which is transmitted to the shaft 149. Since the shaft 149 is connected to the intermediate clamping member 114, the normal force causes a deformation of the upper resilient member 112 and a movement of the intermediate clamping member 114 toward the upper clamping member 110 (vertically upward direction) . Since the intermediate clamping member 114 moves towards the upper clamping member 110, the upper clamping force applied to the upper resilient member 112 by the upper and intermediate clamping members 110, 114 is increased, thereby increasing compressive stresses within the upper resilient member 112. On the other hand, since the intermediate clamping member 114 moves away from the lower clamping members 118a, 118b, the leading and trailing lower clamping forces applied to, respectively, the leading and trailing lower resilient members 116a, 116b decrease, thereby decreasing the compressive stresses within the leading and trailing lower resilient members 116a, 116b. Since the intermediate clamping member 114 has moved generally vertically upward, the longitudinal axis 142 has also moved generally vertically upward. In this instance, the pivoting assembly 100 is in a first configuration. Due to the resilient nature of the resilient members 112, 116a, 116b, when the pivoting assembly 100 is in the first configuration (i.e., offset from the initial configuration), the pivoting assembly 100 is biased toward the initial configuration. In the first configuration, the gaps between the left and right borders 120a, 120b of the upper clamping member 110 and the left and right borders 144a, 144b of the intermediate clamping member 114, and the gaps between the left and right borders 170a, 170b of the leading and trailing lower clamping members 118a, 118b and the leading and trailing left and right borders 145a₁, 145b₁, 145a₂, 145b₂ are still present. In other words, the upper and intermediate clamping members 100, 114 are vertically spaced from one another, and the intermediate and leading and trailing lower clamping members 114, 118a, 118b are vertically spaced from one another.

During operation, when the track system 30 encounters an obstacle, such as a hole or a rock, that is disposed on a left or right side of the longitudinal center plane of the track system 30, the track system 30 can, to some extent, conform to the obstacle. More precisely, one or more of the pivoting assemblies 100, 101, 102, 103 can have their shaft pivot about the longitudinal axis 142 to conform to the obstacle. Upon pivotal motion of the shaft 149, a deformation in a corresponding one of the resilient members 112, 116a, 116b biases the shaft 149, and thus the corresponding one of the pivoting assemblies 100, 101, 102, 103, toward the initial position. This can assist the track system 30 in overcoming the obstacle, and can also assist in better distributing load on the endless track 70.

For example, when an obstacle, a rock for the purposes of this example, that is disposed on a left side of the track system 30 reaches the support wheel assembly 62a (i.e., the rock is longitudinally aligned with the support wheel assembly 62a and the pivoting assembly 100), the left wheel of the support wheel assembly 62a moves in an upward direction because of the rock. This causes the left end of the shaft 149 to also move in the upward direction, such that the intermediate clamping member 114 pivots about the longitudinal axis 142. The pivotal movement of the intermediate clamping member 114 is enabled by, as described hereabove, the resilient nature of the upper resilient member 112 and the leading and trailing lower resilient members 116a, 116b. The pivotal movement of the intermediate clamping member 114 causes the upper resilient member 112 and the leading and trailing lower resilient members 116a, 116b to deform (i.e., undergo further compression).

Deformation of the upper resilient member 112 and the leading and trailing lower resilient members 116a, 116b causes the upper resilient member 112 and the leading and trailing lower resilient members 116a, 116b to exert a biasing force on the intermediate clamping member 114. The biasing force is applied such that the intermediate clamping member 114 is biased towards the first position (i.e., biased toward the initial position), which can assist the support wheel assembly 62a in overcoming the obstacle.

During deformation, the upper engaging portion 130a of the upper resilient member 112 is generally fixed relative to the upper clamping member 110, whereas the lower engaging portion 130b of the upper resilient member 112 is generally fixed relative to the top side 140a of the intermediate clamping member 114. This is, in part, due the interlocking engagement between the protrusions 124, 148a and, respectively, the longitudinal slots 134a, 134b, due to the upper clamping force, and due to the enclosure 180a (i.e., the abutting portions 126a, 126b, 147a, 147b and the borders 120a, 120b, 144a, 144b). Similarly, the upper engaging portions 150a of the leading and trailing lower resilient members 116a, 116b are generally fixed relative to bottom side 140b of the intermediate clamping member 114, whereas the lower engaging portions 150b of the leading and trailing lower resilient members 116a, 116b are generally fixed relative to, respectively, the leading and trailing lower clamping members 118a, 118b. This is, in part, as mentioned above, due to interlocking engagement between the protrusions 148b, 174 and longitudinal slots 154a, 154b, due to the leading and trailing lower clamping forces, and due to the enclosures 180b₁, 180b₂ (i.e., the abutting portions 147a, 147b, 147c, 147d, 176a, 176b and the borders 145a₁, 145b₁, 145a₂, 145b₂, 170a, 170b). In some embodiments, an adhesive could be provided between surfaces to assist in keeping the upper and lower resilient members 112, 116a, 116b fixed relative to the upper, intermediate and lower clamping members 110, 114, 118a, 118b.

During deformation, the above-described relationship reduces slippage between surfaces of the upper and lower resilient members 112, 116a 116b and respective surfaces of the upper, intermediate and lower clamping members 110, 114, 118a, 118b. This reduction of the slippage can result in a reduction in heat generation, can extend life of the upper and lower resilient members 112, 116a, 116b.

Additionally, the encapsulation provided by the upper, intermediate and lower clamping members 110, 114, 118a, 118b aid in preventing rolling of the surfaces of the upper and lower resilient members 112, 116a 116b relative to their respective surfaces. This can, in some instances, provide added stability.

The upper resilient member 112 and the leading and trailing lower resilient members 116a, 116b at least in part deform in compression. For example, in response to the left end of the shaft 149 moving upward, a left side of the upper resilient member 112 and the right side of the lower resilient members 116a, 116b deform in compression. Specifically, compression of the resilient members 112, 116a, 116b is oriented in diagonal directions (see arrows in FIG. 6A); the compression orientation in the upper resilient member 112 is in an upper left direction (from the perspective shown in FIG. 6A), and compression orientation in the leading and trailing lower resilient members 116a, 116b is in a downward right direction (from the perspective shown in FIG. 6A). The resilient members 112, 116a, 116b can also deform in tension, notably in instances where surfaces of the resilient members 112, 116a, 116b are glued to respective engaging portions of the upper, intermediate and lower clamping members 110, 114, 118a, 118b. In some instances, due to the pre-stress in the resilient members 112, 116a, 116b, the resilient members 112, 116a, 116b are not subject to tensile stresses. This can, in some embodiments, extend the life of the resilient members 112, 116a, 116b.

Despite the deformations, the upper resilient member 112 and the leading and trailing lower resilient members 116a, 116b do not slip out of their respective enclosures 180a, 180b₁, 180b₂ in part due to the borders 120a, 120b, 144a, 144b, 145a₁, 145b₁, 145a₂, 145b_{2,}170a, 170b, the protrusions 124, 148a, 148b, 174 and longitudinal slots 134a, 134b, 154a, 154b, and the upper and lower clamping forces.

The pivoting assembly 100 is configured so that once the intermediate clamping member 114 pivots by about 15 degrees about the longitudinal axis 142, the left and/or right wings 243a, 243b of the leading and trailing abutting portions 147a, 147b abut the upper and/or lower clamping members 110, 118a, 118b, thereby limiting pivotal range of motion of the intermediate clamping member 114. Thus, the intermediate clamping member 114 (i.e., the shaft 149) has a pivotal range of motion of about 15 degrees. In some embodiments, the pivotal range of motion could be about 10 degrees or about 5 degrees.

In some instances, as described above, the pivoting assembly 100 is configured to limit vertical displacement of the intermediate clamping member 114 relative to the upper clamping member 110 and/or leading and trailing lower clamping members 118a, 118b via abutment of the left and right borders 120a, 120b of the upper clamping member 110 with the left and right borders 144a, 144b of the intermediate clamping member 114, and/or via abutment of the left and right borders 170a, 170b of the leading and trailing lower clamping members 118a, 118b with the leading and trailing left and right borders 145a₁, 145b₁, 145a₂, 145b₂.

It is to be noted that having separate upper and lower resilient members 112, 116 can reduce the amount of material required to manufacture the pivoting assembly 100 compared to if a resilient member were to surround the intermediate clamping member 114. Additionally, since the upper and lower clamping members 110, 118a, 118b are removably connected to one another, either one of the resilient members 112, 116a, 116b can be individually replaced, without necessarily replacing the other ones. This can reduce costs associated with maintenance of the track system 30.

### Pivoting Assembly According to a Second Embodiment

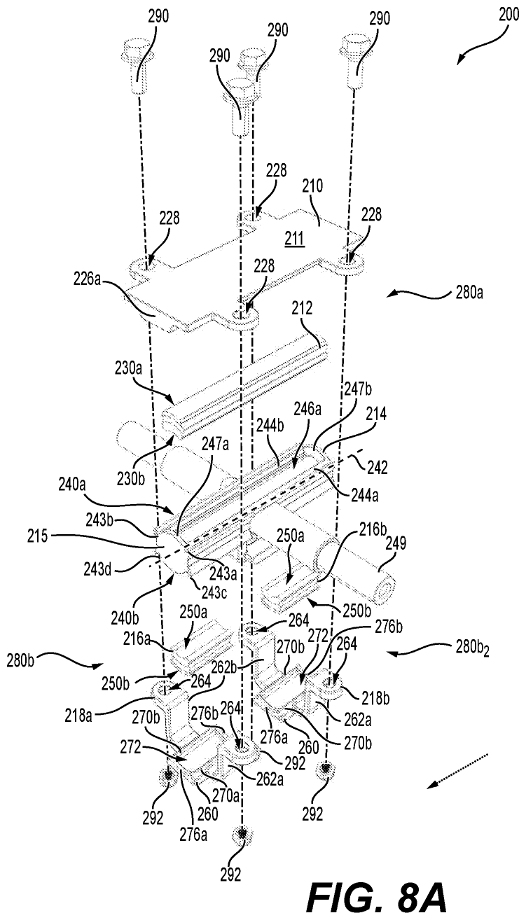

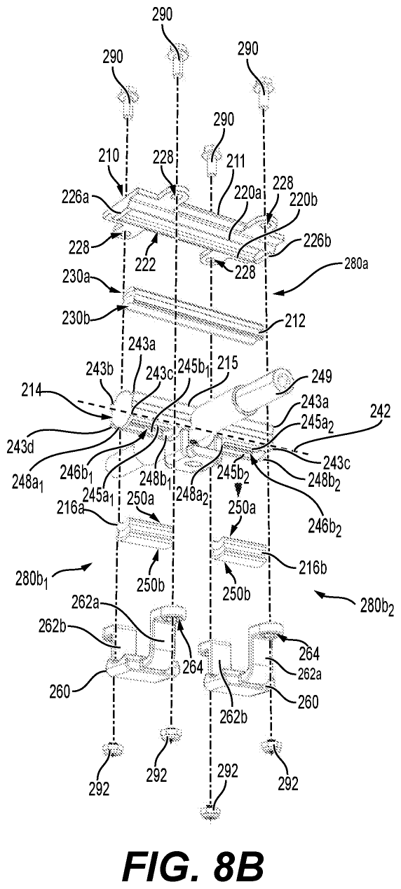

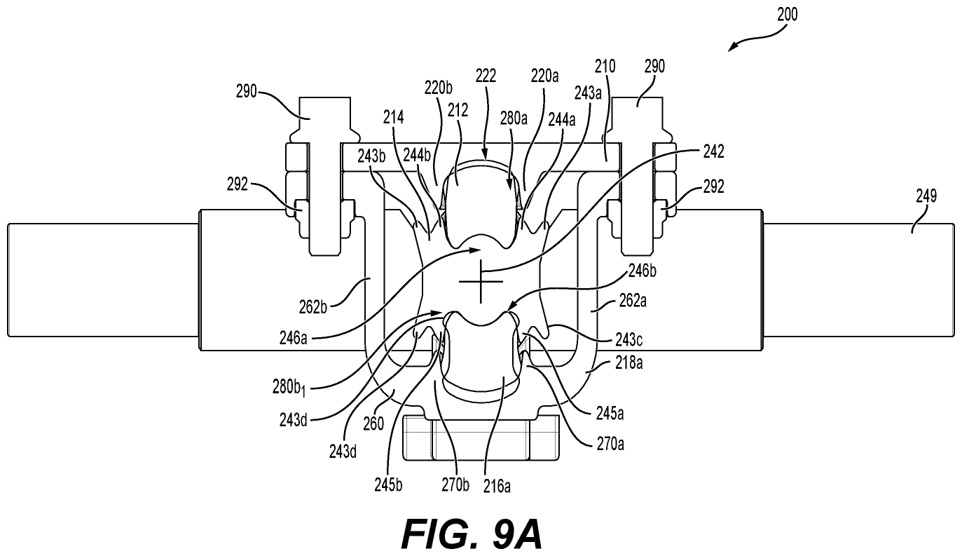

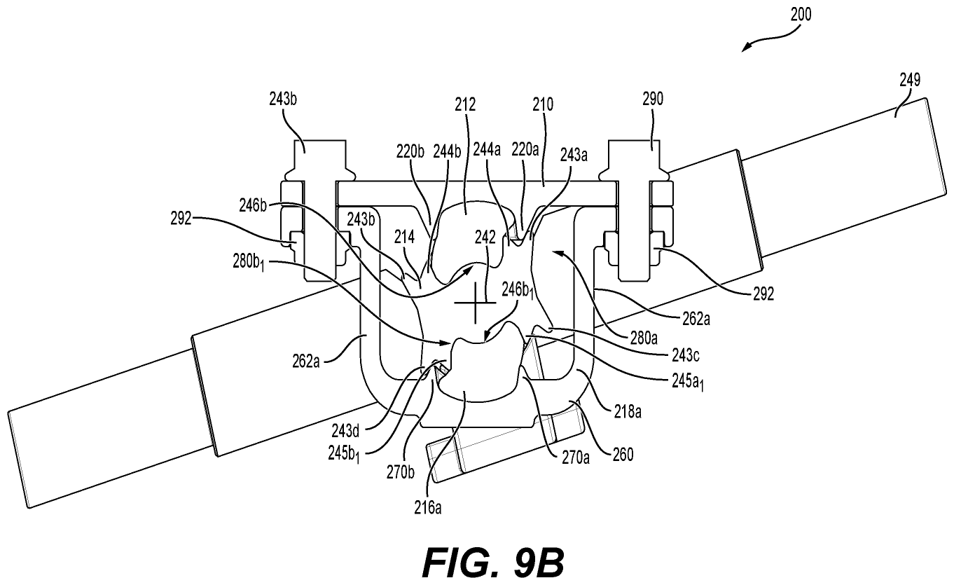

Referring to FIGS. 8A, 8B, 9A and 9B, an alternative embodiment of the pivoting assembly 100, namely pivoting assembly 200, will now be described in greater detail.

The pivoting assembly 200 includes an upper clamping member 210, an upper resilient member 212, an intermediate clamping member 214, leading and trailing lower resilient members 216a, 216b and leading and trailing lower clamping members 218a, 218b.

The upper clamping member 210 is, in the present embodiment, a bottom part of the lower frame member 56. Specifically, the upper clamping member 210 is a lower wall of the lower frame member 56. It is contemplated, however, that the upper clamping member 210 could be separate and distinct from the lower frame member 56. For example, the upper clamping member 210 could be configured to be fastened to the lower frame member 56.

The upper clamping member 210 has a generally elongate body 211 that defines a recessed upper channel 222 and four connecting apertures 228. It is contemplated that in other embodiments, there could be more or fewer than four connecting apertures. As will be described below, the connecting apertures 228 are configured to receive a fastener therein. On a bottom surface of the elongate body 211, the upper channel 222 is defined by left border 220a, a right border 220b and leading and trailing abutting portions 226a, 226b. The left and right borders 220a, 220b are laterally spaced and extend longitudinally along the elongate body 211. The upper channel 222, which is configured to receive an upper part of the upper resilient member 212, defines an arcuate profile. In the illustrated embodiment, the upper channel 222 is concave, but it is contemplated that the upper channel 222 could be convex. In some embodiments, the upper channel 222 could only be defined by the left and right borders 220a, 220b. As will be described below, the left and right borders 220a, 220b and the leading and trailing abutting portions 226a, 226b can assist in preventing the upper resilient member 212 from slipping out of the upper channel 222.

The upper resilient member 212 has an upper engaging portion 230a and a lower engaging portion 230b. The upper engaging portion 230a is configured to operationally engage the upper clamping member 210. The upper engaging portion 230a, which is configured to be received in the upper channel 222, has an arcuate profile. Specifically, the upper engaging portion 230a is convex, and is complementary to the concave upper channel 222. It is contemplated that in some embodiments, the upper engaging portion 230a could be concave. The lower engaging portion 230b is configured to operationally engage the intermediate clamping member 214. The lower engaging portion 230b defines an arcuate profile. More precisely, the lower engaging portion 230b is concave, but it is contemplated that in some embodiments, the lower engaging portion 230b could be convex.

The upper resilient member 212 is made of a polymeric material. In the present embodiment, the upper resilient member 212 is made of rubber. The upper resilient member 212 can be made of any elastic material that is able to elastically deform under the compressive and/or tensile forces applied thereto through movement of a shaft 249. More specifically, a distance between the upper clamping member 210 and the intermediate clamping member 214 may be selected so as to pre-stress the upper resilient member 212 according to a predetermined amount. The predetermined amount may be selected such that the upper resilient member 212 can accommodate further compression and remain within the elastic limit of the upper resilient member 212.

With continued reference to FIGS. 8A, 8B, 9A and 9B, the intermediate clamping member 214 is an elongate member 215, which has a top side 240a and a bottom side 240b. A longitudinal axis 242 extends generally parallel to a longitudinal center plane of the track system 30 and through the intermediate clamping member 214. In some embodiments, the longitudinal axis 242 is aligned with a center of the intermediate clamping member 214. As will be described in greater detail below, the intermediate clamping member 214, and thus the longitudinal axis 242, is moveable due to the resilient nature of the upper resilient member 212 and the leading and trailing lower resilient members 216a, 216b. For example, the longitudinal axis 242 can move vertically and/or horizontally. The intermediate clamping member 214 has an upper left wing 243 a, an upper right wing 243b, a lower left wing 243c and a lower right wing 243d. As will be described below, the upper and lower left and right wings 243a, 243b, 243c, 243d can assist in limiting the pivotal range of motion of the intermediate clamping member 214 about the longitudinal axis 242. In some embodiments, the pivotal range of motion of the intermediate clamping member 215 is about 15 degrees. In some instances, the upper and lower left and right wings 243a, 243b, 243c, 243d can also assist in limiting longitudinal range of motion of the intermediate clamping member 214 relative to the upper and lower clamping members 210, 218a, 218b.

The intermediate clamping member 214 also has the shaft 249. The shaft 249 is generally disposed at a longitudinal center of the intermediate clamping member 214, and extends laterally (i.e., generally perpendicular to the longitudinal axis 242) in either lateral directions. In the present embodiment, the shaft 249 is selectively fixedly connected to the elongate member 215 via a fastener (not shown). In other embodiments, the shaft 249 could be integral with the elongate member 215. The shaft 249 is configured to rotationally or pivotally connect to the left and right wheels of the support wheel assembly 62a at, respectively, left and right ends of the shaft 249. In some embodiments, the shaft 249 could be configured to have, instead of a single wheel, a tandem wheel assembly connected thereto. When the pivoting assembly 200 is in the initial configuration (shown in FIG. 9A), the intermediate clamping member 214 is in an initial position, in which the shaft 249 is generally perpendicular to the longitudinal center plane of the track system 30, and generally horizontal.

Since the intermediate clamping member 214 and the shaft 249 are connected to one another, and since the intermediate clamping member 214 is moveable, to a certain degree, relative to the upper and lower clamping members 320, 218a, 218b, the intermediate clamping member 214 moves in response to the wheel assembly 62a moving. Since the longitudinal axis 242 is defined by the intermediate clamping member, as a result of the movement of the intermediate clamping member 114, the longitudinal axis 242 moves accordingly.

The intermediate clamping member 214 defines, on the top side 240a, a recessed upper intermediate channel 246a. The upper intermediate channel 246a is defined by a left border 244a, a right border 244b and leading and trailing abutting portions 247a, 247b. The left and right borders 244a, 244b are laterally spaced and extend longitudinally along the elongate member 215. The upper intermediate channel 246a defines an arcuate profile. Specifically, the upper intermediate channel 246a defines a convex profile. Additionally, the intermediate clamping member 214 defines, on the bottom side 240b ,leading and trailing recessed lower channels 246b₁, 246b₂. The leading lower channel 246b₁ is defined by a left border 245a₁, a right border 245b₁, and leading and trailing abutting portions 248a₁, 248b₁. The trailing lower channel 246b₂ is defined by a left border 245a₂, a right border 245b₂, and leading and trailing abutting portions 248a₂, 248b₂. The leading lower channel 246b₁ is disposed longitudinally forward from the shaft 249, and the trailing lower channel 246b₂ is disposed longitudinally rearward from the shaft 249. The leading and trailing lower channels 246b₁, 246b₂ each define an arcuate profile. Specifically, the leading and trailing lower channels 246b₁, 246b₂ each define a convex profile, but it is contemplated that the leading and trailing lower channels 246b₁, 246b₂ could define concave profiles.

Still referring to FIGS. 8A, 8B, 9A and 9B, the leading and trailing lower resilient member 216a, 216b will now be described in greater detail. The leading and trailing lower resilient members 216a, 216b are similar to one another, and are smaller versions of the upper resilient member 212. It is contemplated that in some embodiments, the leading and trailing lower resilient members 216a, 216b could be one lower resilient member or three or more resilient members. The leading and trailing lower resilient members 216a, 216b are made of a polymeric material. In the present embodiment, the leading and trailing lower resilient members 216a, 216b are made of rubber. The leading lower resilient member 216a is disposed longitudinally forward from the shaft 249, and is partially received in the leading lower channel 246b₁. The trailing lower resilient member 216b is disposed longitudinally rearward from the shaft 249, and is partially received in the trailing lower channel 246b₂. As the leading and trailing lower resilient members 216a, 216b are similar, only the leading lower resilient member 216a will be described herewith.

The leading lower resilient member 216a has an upper engaging portion 250a and a lower engaging portion 250b. The upper engaging portion 250a is configured to operationally engage the bottom side 240b of the intermediate clamping member 214. More precisely the upper engaging portion 250a, which is configured to be received in the lower channel 246b, defines an arcuate profile. The upper engaging portion 250a is concave, but it is contemplated that in some embodiments, the upper engaging portion 250a could be convex. On the other hand, the lower engaging portion 250b is configured to operationally engage the leading lower clamping member 218a. The lower engaging portion 250b defines an arcuate profile. More precisely, the lower engaging portion 250b is convex, but it is contemplated that in some embodiments, the lower engaging portion 250b could be concave.

The leading and trailing lower clamping members 218a, 218b are selectively connected to the upper clamping member 210. Additionally, the leading and trailing lower clamping members 218a, 218b engage with, respectively, the leading and trailing lower resilient members 216a, 216b. As such, the leading lower clamping member 218a is disposed longitudinally forward from the shaft 249, whereas the trailing lower clamping member 218b is disposed longitudinally rearward from the shaft 249. As the leading and trailing lower clamping members 218a, 218b are similar, only the leading clamping member 218a will be described in detail herewith.

The leading lower clamping member 218a has a lower portion 260 and lateral portions 262a, 262b extending upwardly from the lower portion 260. Each of the lateral portions 262a, 262b defines a connecting aperture 264 at a top end thereof. The connecting apertures 264 are configured to receive bolts 290 therethrough. More specifically, upon assembly of the pivoting assembly 200, the connecting apertures 264 are aligned with corresponding connecting apertures 228 of the upper clamping member 210, and the bolts 290 and the nuts 292 can be used to fasten the leading lower clamping member 218a to the upper clamping member 210. Thus, the leading lower clamping member 218a is removably connectable to the upper clamping member 210. This enables an operator to easily access components of the pivoting assembly 200. This can be also useful for maintenance purposes and/or to replace worn out components instead of having to replace the whole pivoting assembly 200.

Focusing on the lower portion 260, the leading lower clamping member 218a defines a recessed lower channel 272. The lower channel 272 is defined by a left border 270a, a right border 270b and leading and trailing abutting portions 276a, 276b. The lower channel 272, which is configured to receive a lower part of the leading lower resilient member 216a, defines an arcuate profile. In the present embodiment, the lower channel 272 is concave, but it is contemplated that the lower channel 272 could be convex. In some embodiments, the lower channel 272 could only be defined by the left and right borders 270a, 270b. As will be described below, the left and right borders 270a, 270b and the leading and trailing abutting portions 276 can assist in preventing the lower resilient member 216a from slipping out of the lower channel 272.

In some embodiments, the longitudinal axis 242 is partly defined by the upper and lower resilient members 112, 116a, 116b. More specifically, in some embodiments, the arcuate profile of the lower engaging portion 230b of the upper resilient member 212 and the arcuate profiles of the upper engaging portions 250a of the leading and trailing lower resilient members 216a, 216b share a common virtual center point in which is defined the longitudinal axis 242. Thus, the upper and lower resilient members 112, 116a, 116b co-operate to support the intermediate clamping member 214 (i.e, the upper and lower resilient members 112, 116a, 116b cooperate to support the intermediate clamping member 212 at the longitudinal axis 242).

Thus, the upper resilient member 212 is disposed between the upper clamping member 210 and the intermediate clamping member 214, the leading lower resilient member 216a is disposed between the intermediate clamping member 214 and the leading lower clamping member 218a, and the trailing lower resilient member 216b is disposed between the intermediate clamping member 214 and the trailing lower clamping member 218b. More precisely, the upper engaging portion 230a of the upper resilient member 212 is received in the upper channel 222 of the upper clamping member 210 and the lower engaging portion 230b of the upper resilient member 212 is received in the upper intermediate channel 246a of the intermediate clamping member 214. The upper engaging portion 250a of the leading lower resilient member 216a is received in the leading lower channel 246b₁ of the intermediate clamping member 214, and the lower engaging portion 250b of the leading lower resilient member 216a is received in the lower channel 272 of the leading lower clamping members 218a. The upper engaging portion 250a of the trailing lower resilient member 216b is received in the trailing lower channel 246b₂ of the intermediate clamping member 214, and the lower engaging portion 250b of the trailing lower resilient member 216b is received in the lower channel 272 of the trailing lower clamping members 218b.

As the upper clamping member 210 is being connected to the leading and trailing lower clamping members 218a, 218b via the bolts and nuts 290, 292, the upper clamping member 210 and the intermediate clamping member 214 form an upper capped enclosure 280a, and gradually apply an upper clamping force to the upper resilient member 212. Similarly, the intermediate clamping member 214 and the leading lower clamping member 218a form a lower enclosure 280b₁, and gradually apply a leading lower clamping force to the leading lower resilient member 216a. Also, the intermediate clamping member 214 and the trailing lower clamping member 218b form a lower enclosure 280b₂, and gradually apply a trailing lower clamping force to the trailing lower resilient member 216b.

Thus, the engagement between the upper channel 222 of the upper clamping member 210 and the upper engaging portion 230a of upper resilient member 212, the engagement between the lower engaging portion 230b of the upper resilient member 212 and the upper intermediate channel 246a of the intermediate clamping member 214, the engagement between the lower channels 246b₁, 246b₂ of the intermediate clamping member 214 and the upper engaging portions 250a of the leading and trailing lower resilient members 216a, 216b and the engagement between the lower engaging portions 250b of the leading and trailing lower resilient members 216a, 216b and the lower channels 272 of the leading and trailing lower clamping members 218a, 218b are all gradual engagements. As all the engagements are generally similar, only the engagement between the upper clamping member 210 and the upper resilient member 212 and the engagement between the upper resilient member 212 and the intermediate clamping member 214 will be described herewith.

At first, when the upper clamping member 210 is barely connected to the leading and trailing lower clamping members 218a, 218b, a first upper clamping force is applied by the upper and intermediate clamping members 210 to the upper resilient member 212. In this first state, the upper engaging portion 230a engages the upper channel 222 with a first initial contact area. Likewise, the lower engaging portion 230b engages the upper intermediate channel 246a with a second initial contact area. In some embodiments, the first initial contact area is equal to the second initial contact area.

Then, by way of tightening the bolts 290 and nuts 292, the pivoting assembly 200 can be adjusted to a second state. In the second state, in which the upper clamping member 210 is more tightly connected to the leading and trailing lower clamping members 218a, 218b than in the first state, a second upper clamping force is applied by the upper and intermediate clamping members 210, 214 to the upper resilient member 212. The second upper clamping force is greater than the first upper clamping force. In this second state, the upper engaging portion 230a engages the upper channel 222 with a third contact area. Likewise, the lower engaging portion 230b engages the upper intermediate channel 246a with a fourth contact area. In some embodiments, the third contact area is equal to the fourth contact area. The third and fourth contact areas are, respectively, greater than the first and second contact areas.

In some embodiments, when the pivoting assembly 200 is in the second state, the pivoting assembly 200 is in an initial configuration. In the initial configuration, components of the pivoting assembly 200 are in initial positions, and there is a gap between the left and right borders 220a, 220b of the upper clamping member 210 and the left and right borders 244a, 244b of the intermediate clamping member 214. Additionally, there is also a gap between the left and right borders 270a, 270b of the leading and trailing lower clamping members 118a, 118b and the leading and trailing left and right borders 245a₁, 245b₁, 245a₂, 245b₂. These gaps extend parallel to the longitudinal axis 242 and can provide clearance for when the resilient members 212, 216a, 216b undergo deformation. In cases where the resilient members 212, 216a, 216b are deformed such that their sides bulge outwardly, the gaps can accommodate the bulging.

The gradual engagement of the components described hereabove can assist in keeping debris from lodging themselves between the upper clamping member 210 and the upper resilient member 212, between the upper resilient member 212 and the intermediate clamping member 214, between the intermediate clamping member 214 and the leading and trailing lower resilient members 216a, 216b and between the leading and trailing lower resilient members 216a, 216b and the leading and trailing lower clamping members 218a, 218b, because debris are pushed out from the corresponding channel. This can, in turn, extend life of the resilient members 212, 216a, 216b. It is to be noted that this gradual engagement is not present in the support structure 100, as the engaging portions are generally flat, and hence there is no change in area of contact. It is to be noted that in some implementations of the present embodiment, there may not be a gradual engagement between the resilient members 212, 216a, 216b and the clamping members 210, 214, 218a, 218b.

As mentioned hereabove, the connection of the upper and lower clamping members 210, 218a, 218b result in upper and lower clamping forces, which induce stresses within the upper resilient member 212 and the leading and trailing lower resilient members 216a, 216b. Thus, the upper resilient member 212 and the leading and trailing lower resilient members 216a, 216b are pre-stressed before undergoing any deformation due to a movement of the intermediate clamping member 214.

In some embodiments, the connection between the upper clamping member 210 and the leading and trailing lower clamping members 218a, 218b enables adjustment of the respective clamping forces and the extent of pre-compression of the upper resilient member 212 and the leading and trailing lower resilient members 216a, 216b.

Without being held to any theory, it is thought that pre-stressing the resilient members 112, 116 can reduce an extent of compression compared to a non-stressed resilient member. The upper resilient member 212 and the leading and trailing lower resilient members 216a, 216b being pre-stressed can help dampen vibrations, and can increase biasing forces that would otherwise be produced. In some instances, pre-stressing the resilient members 212, 216a, 216b can make it so that the resilient members 212, 216a, 216b are not subjected to tensile forces, which can extend life of said resilient member.

Upon pivotal movement of the intermediate clamping member 214 about the longitudinal axis 242, the upper resilient member 212 and the leading and trailing lower resilient members 216a, 216b undergo resilient deformation, which causes the upper resilient member 212 and the leading and trailing lower resilient members 216a, 216b to bias the intermediate clamping member 214 toward the initial position.

During deformation, slippage between surfaces of the upper and lower resilient members 212, 216a 216b and respective surfaces of the upper, intermediate and lower clamping members 210, 214, 218a, 218b can be reduced by the use of an adhesive.

This reduction in slippage can result in a reduction of heat generation, which in turn can extend life of the upper and lower resilient members 212, 216a, 216b.

Additionally, the encapsulation provided by the upper, intermediate and lower clamping members 210, 214, 218a, 218b aid in preventing rolling of the surfaces of the upper and lower resilient members 212, 216a, 216b relative to their respective surfaces. As a result, a life of the upper, intermediate and lower clamping members 210, 214, 218a, 218b can be extended due to a decrease in material fatigue.

The upper resilient member 212 and the leading and trailing lower resilient members 216a, 216b at least in part deform in compression. For example, when the left end of the shaft 249 moves upward, a left side of the upper resilient member 212 and the right side of the lower resilient members 216a, 216b deform in compression due to the movement of the intermediate clamping member 214. Specifically, compression of the resilient members 212, 216a, 216b are oriented in diagonal directions; the compression orientation in the upper resilient member 212 is in an upper left direction, and compression orientation in the leading and trailing lower resilient members 216a, 216b is in a downward, right direction. The resilient members 212, 216a, 216b can also deform in tension, notably in instances where surfaces of the resilient members 112, 116a, 116b are glued to respective engaging portions of the upper, intermediate and lower clamping members 110, 114, 118a, 118b. In some instances, due to the pre-stress in the resilient members 112, 116a, 116b, the resilient members 112, 116a, 116b are not subject to tensile stresses. This can, in some embodiments, extend a life of the resilient members 112, 116a, 116b.

Despite the compression, the upper resilient member 212 and the leading and trailing lower resilient members 216a, 216b do not slip out of their respective enclosures 280a, 280b1, 280b2 in part due to the borders 220a, 220b, 244a, 244b, 245a1, 245b1, 245a2, 245b2, 270a, 270b, the protrusions 224, 248a, 248b, 274 and longitudinal slots 234a, 234b, 254a, 254b, and the upper and lower clamping forces.

The pivoting assembly 200 is configured to limit pivotal range of motion of the intermediate clamping member 214 by about 15 degrees. In some embodiments, the pivotal range of motion could be about 10 degrees or about 5 degrees. In the present embodiment, once the intermediate clamping member 214 has pivoted by about 15 degrees, as shown in FIG. 9B, one of the wings 243a, 243b abuts the upper clamping member 210, and one of the wings 243c, 243d abuts the lower clamping member 218. For example, upon vertical displacement of the support wheel assembly 62a causing the left end of the shaft 249 to move in an upward direction, the upper left wing 243a abuts the left border 220a of the upper clamping member 210 and the lower right wing 243b abuts the right border 270b of the leading lower clamping member 218a.

### Pivoting Assembly According to a Third Embodiment

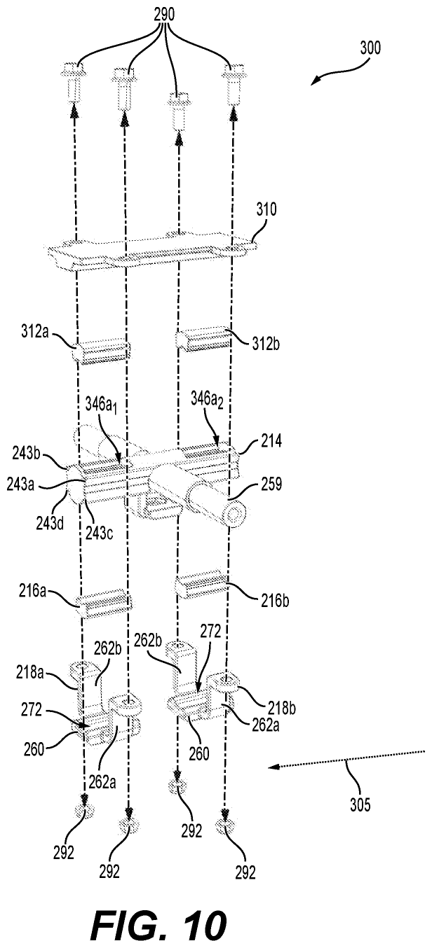

Referring to FIG. 10, an alternative embodiment of the pivoting assemblies 100, 200, namely pivoting assembly 300, is shown. The pivoting assembly 300, the forward direction of which is shown by arrow 305, is similar to the pivoting assembly 200, and thus, features of the pivoting assembly 300 similar to those of the pivoting assembly 200 have been labeled with the same reference numerals and will not be described in detail again. The pivoting assembly 300 is notably different from the pivoting assembly 200 in that there are two upper resilient members 312a, 312b instead of the upper resilient member 212. To accommodate for the two upper resilient members 312a, 312b, the upper clamping member 210 defines leading and trailing upper channels (not shown), and the intermediate clamping member 214 defines leading and trailing upper recesses 346a₁, 346a₂. Part of the upper resilient member 312a is received in the leading upper recess 346a₁, and part of the upper resilient member 312b is received in the trailing upper recess 346a₂.

### Pivoting Assembly According to a Fourth Embodiment

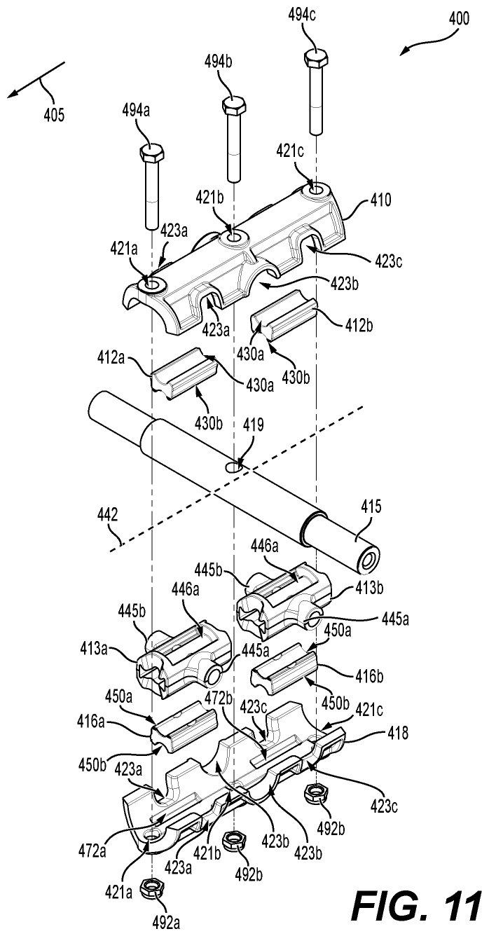

Referring to FIG. 11, an alternative embodiment of the pivoting assemblies 100, 200, 300, namely pivoting assembly 400, is shown.

In this embodiment, the pivoting assembly 400, the forward direction of which is shown by arrow 405, has an upper clamping member 410, leading and trailing upper resilient members 412a, 412b, leading and trailing connecting members 413a, 413b, a shaft 415, leading and trailing lower resilient members 416a, 416b and a lower clamping member 418.

Broadly, in this embodiment, the leading and trailing connecting members 413a, 413b are fixedly connected to the frame 50 of the track system 30, and the shaft 415 is selectively fixedly connected to the upper and lower clamping members 410, 418. Additionally, the upper clamping member 410, the shaft 415 and the lower clamping member 418 are movable relative to the connecting members 413a, 413b due to resilient nature of the leading and trailing upper and lower resilient members 412a, 412b, 416a, 416b.

The upper and lower clamping members 410, 418 are similar (mirror images), and hence only the upper clamping member 410 will be described herewith. It is contemplated that in some embodiments, the upper and lower clamping members 410, 418 could differ from one embodiment to another.

The upper clamping member 410 defines three longitudinally spaced apertures 421a, 421b, 421c at a top thereof. The apertures 421a, 421b, 421c are configured to, respectively, receive bolts 490a, 490b, 490c therethrough. The upper clamping member 410 further defines, on each lateral side thereof, a leading side recess 423a, an intermediate side recess 423b, and a trailing side recess 423c. The leading side recesses 423a are configured to partially receive the leading connecting member 413a therethrough, the intermediate side recesses 423b are configured to partially receive the shaft 415 therethrough, and the trailing side recesses 423c are configured to partially receive the trailing connecting member 413b therethrough. The upper clamping member 410 also has leading and trailing channels 472a, 472b (shown in the lower clamping member 418 in FIG. 11). The leading and trailing channels 472a, 472b are similar to the channels 222, 272, and hence will not be re-described herewith.

The leading and trailing upper and lower resilient members 412a, 412b, 416a, 416b are similar to the upper resilient member 212 and the leading and trailing resilient members 216a, 216b, and hence will not be re-described in detail herewith. One notable difference, however, is that upper and lower engaging portions 430a, 430b, 450a, 450b of the leading and trailing upper and lower resilient members 412a, 412b, 416a, 416b define concave profiles. It is contemplated that one or more of the upper and lower engaging portions 430a, 430b, 450a, 450b of the leading and trailing upper and lower resilient members 412a, 412b, 416a, 416b could be convex.

With continued reference to FIG. 11, the leading and trailing connecting members 413a, 413b will now be described. As the leading and trailing connecting members 413a, 413b are similar, only the leading connecting member 413a will be described herewith.

The leading connecting member 413a defines a recessed upper channel 446a and a recessed lower channel 446b. The upper and lower channels 446a, 446b are similar to the upper and lower intermediate channels 246a, 246b and hence will not be re-described in detail herewith. One notable difference is that the upper and lower channels 446a, 446b each define a convex profile. In some embodiments, one or both of the upper and lower channels 446a, 446b could define a concave profile. The upper channel 446a of the leading connecting member 413a is configured to receive part of the leading upper resilient member 412a, and the lower channel 446b of the leading connecting member 413a is configured to receive part of the leading lower resilient member 416a.

The leading connecting member 413a further has left and right connecting portions 445a, 445b. The leading connecting member 413a defines an aperture 445c that extends through the left and right connecting portions 445a, 445b. The aperture 445c is configured to receive one or two fasteners therein for fixedly connecting the leading connecting member 413a to the frame 50. It is contemplated that in other embodiments, the connecting member 413a could be fixedly connected to another structure. It is contemplated that in some embodiments, the structure to which the connecting member 413a is fixedly connected is moveable.

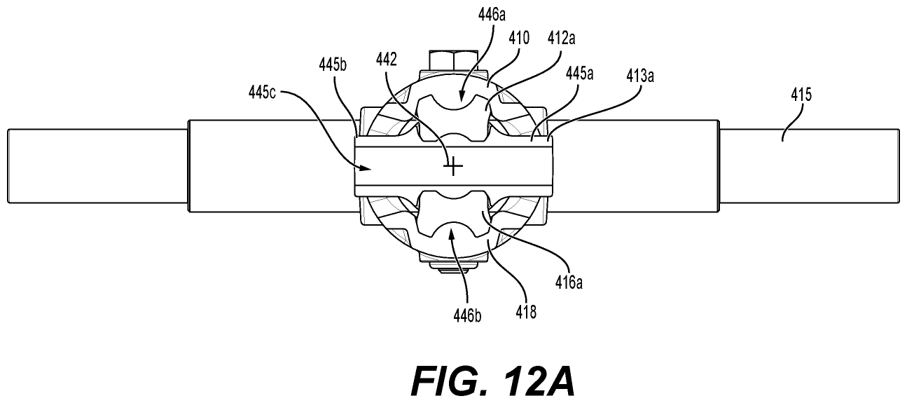

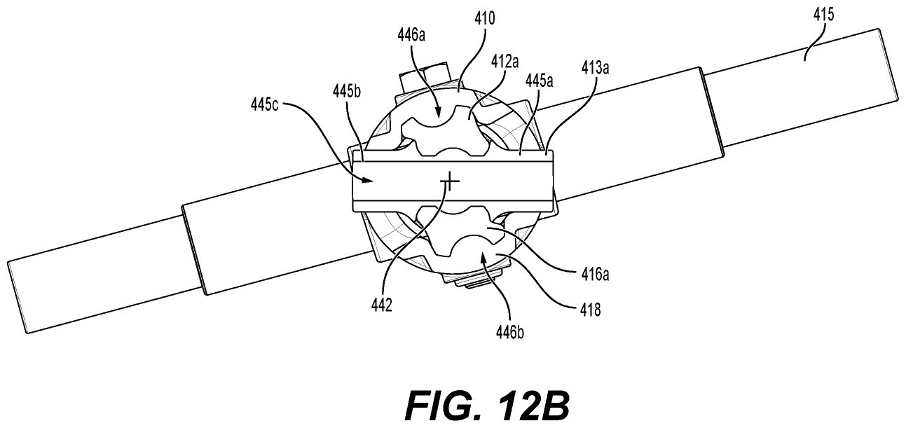

In the present embodiment, the shaft 415 is a standalone component. The shaft 415 defines an aperture 419 at a center thereof for receiving a fastener therein. In the present embodiment, the aperture 419 is configured to receive the bolt 494b therein. As will be described below, the shaft 415 is removably connected to the upper and lower clamping members 410, 418. It is contemplated that in some embodiments, the shaft 415 could be connected to the upper and lower clamping members 410, 418 differently. When the pivoting assembly 400 is in the initial configuration, the shaft 415 defines an initial position (shown in FIG. 12A). As will be described below, the shaft 415 is pivotable about longitudinal axis 442.

To assemble the pivoting assembly 400, the bolts 494a, 494b, 494c are respectively received in the apertures 421a, 421b, 421c of the upper and lower clamping members 410, 418. Additionally, the bolt 494b is also received in the aperture 419 of the shaft 415. Thus, the shaft 415 is rotationally fixed to the upper and lower clamping members 410, 418. The bolts 494a, 494b, 494c are respectively connected to nuts 492a, 492b, 492c.

Referring to FIGS. 12A and 12B, in this embodiment, upon movement of the shaft 415, for instance due to an obstacle such as a rock or a ditch, the upper and lower clamping members 415 also pivot with the shaft 415 relative to the leading and trailing connecting members 413a, 413b. Indeed, the leading and trailing connecting members 413a, 413b remain fixed to the frame 50. Also, upon pivotal movement of the shaft 415, the leading and trailing upper and lower resilient members 412a, 412b, 416a, 416b undergo resilient deformation, which causes the leading and trailing upper and lower resilient members 412a, 412b, 416a, 416b to bias the shaft 415 (and thus the upper and lower clamping members 410, 418) back toward their initial positions.

The leading and trailing upper and lower resilient members 412a, 412b, 416a, 416b deform similarly to the resilient members 212, 216a, 216b and hence, the deformation will not be re-described herewith.

The pivoting assembly 400 can provide a better control of the oscillations that occurs therein (i.e., pivotal movement of the shaft 415), as there are additional anchorage points to the frame 50.

In some embodiments, disconnection of the pivoting assembly 400 from the frame 50 is made easy, because there are less fasteners, and because the fasteners can be more easily accessible, since they are to be accesses from a lateral side of the frame 50, rather than from underneath the frame 50.

### Pivoting Assembly According to a Fifth Embodiment

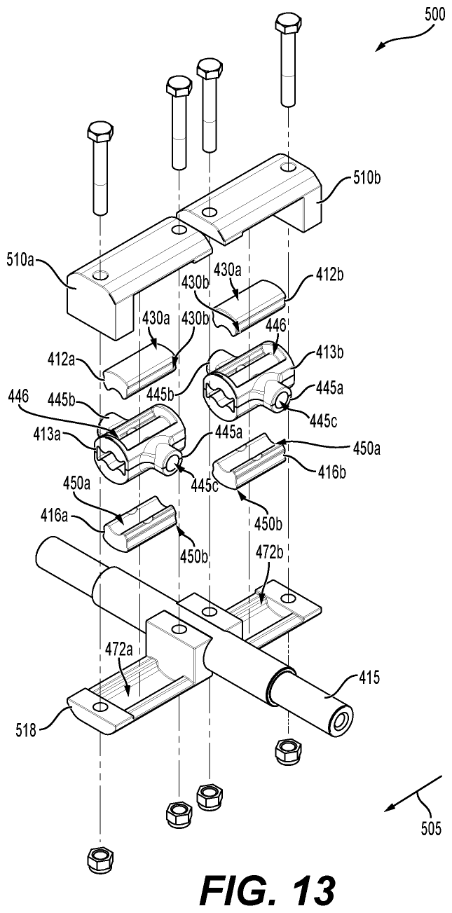

Referring to FIG. 13, an alternative embodiment of the pivoting assemblies 100, 200, 300, 400, namely pivoting assembly 500, will now be described. The pivoting assembly 500, the forward direction of which is indicated by arrow 505, is similar to the pivoting assembly 400, and hence will not be re-described in detail. Features of the pivoting assembly 500 similar to those of the pivoting assembly 400 have been labeled with the same reference numerals and will not be re-described again.

This pivoting assembly 500, notably differs from the pivoting assembly 400 in that there are two upper clamping members 510a, 510b instead of one upper clamping member 410. Additionally, there is one lower clamping member 518 instead of two lower clamping members 418a, 418b, and the shaft 415 is integral to the lower clamping member 518.

In this embodiment, the upper engaging portions 430a of the leading and trailing upper resilient members 412a, 412b and the lower engaging portions 450b of the leading and trailing lower resilient members 416a, 416b define a convex profile, whereas the lower engaging portions 430b of the leading and trailing upper resilient members 412a, 412b and the upper engaging portions 450a of the leading and trailing lower resilient members 416a, 416b define a concave profile.

### Pivoting Assembly According to a Sixth Embodiment

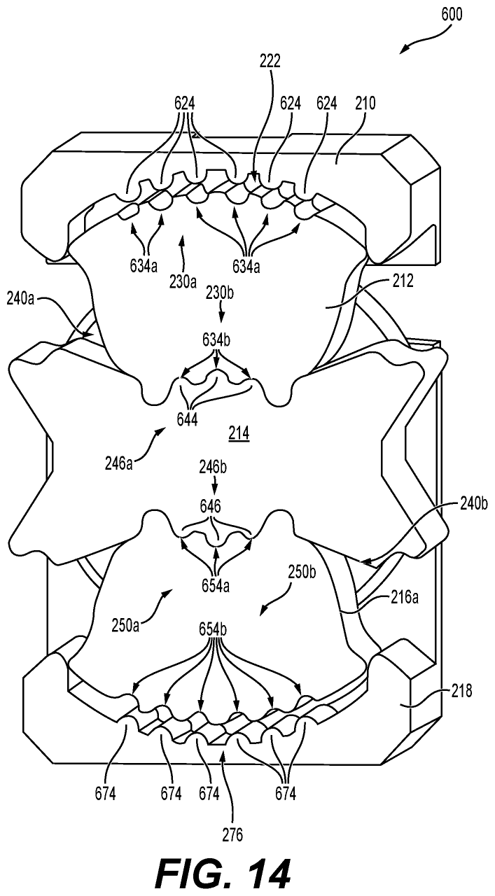

An alternative embodiment of the pivoting assemblies 100, 200, 300, 400, 500 namely pivoting assembly 600, will now be described with reference to FIG. 14, in which the pivoting assembly 600 is only partially shown. The pivoting assembly 600 is similar to the pivoting assembly 200. Features of the pivoting assembly 600 similar to those of the pivoting assemblies 200 have been labeled with the same reference numerals and will not be described in detail again herewith.

In this embodiment, the upper clamping member 210 has, within the upper channel 222, inter-engageable members 624. Likewise, the lower clamping member 218 has, within the lower channel 276, inter-engageable members 674. The protrusions 624, 674 are longitudinal protrusions 624, 674 that extend, respectively, into the upper and lower channels 222, 276. It is contemplated that the orientation of the protrusions 624,674 could be different.

With reference to the upper resilient member 212, the upper engaging portion 230a has inter-engageable members 634a. The inter-engageable members 634a are longitudinal slots 634a defined in the upper resilient member 212. The lower engaging portion 230b also has inter-engageable members 634b. The inter-engageable members 634b are longitudinal slots 634b defined in the upper resilient member 212. Likewise, with reference to the lower resilient member 216a, the upper engaging portion 250a has inter-engageable members 654a. The inter-engageable members 654a are longitudinal slots 654a defined in the lower resilient member 216a. The lower engaging portion 230b also has inter-engageable members 654b. The inter-engageable members 654b are longitudinal slots 654b defined in the lower resilient members 216a.

Furthermore, the intermediate clamping member 214 has, within the upper intermediate channel 246a, inter-engageable members 644. The intermediate clamping member 214 also has, within the lower channel 246b, inter-engageable members 646. The inter-engageable members 644, 646 are longitudinal protrusions.

The protrusions 624 of the upper clamping member 210 are complementary to the longitudinal slots 634a of the upper engaging portion 230a of the upper resilient member 212, and the protrusions 644 of the intermediate clamping member 214 are complementary to the longitudinal slots 634b of the lower engaging portion 230b of upper resilient member 212. Similarly, the protrusions 646 of the intermediate clamping member 214 are complementary to the longitudinal slots 654a of the upper engaging portion 250a of the lower resilient member 216a, and the protrusions 674 of the lower clamping member 218 are complementary to the longitudinal slots 654b of the lower engaging portion 250b of lower resilient member 216a.

It is understood that in some embodiments, the upper and/or lower resilient members 212, 216a could have the protrusions, and the upper and/or clamping members 210, 218 and/or the intermediate clamping member 214 could define the longitudinal slots.

The protrusions 624, 644, 646, 674 interact with respective longitudinal slots 634a, 634b, 654a, 654b to provide a mechanical interlock between their respective components. As a result, upon deformation, slippage between the upper and lower resilient members 212, 216a and the upper clamping member 210, the intermediate clamping member 214 and lower clamping 218 is minimized.

More specifically, the upper engaging portion 230a is generally fixed relative to the upper clamping member 210, the lower engaging portion 230b is generally fixed to the top side 240a of the intermediate clamping member 214, the upper engaging portion 250a is generally fixed relative to the bottom side 240b of the intermediate clamping member 214, and the lower engaging portion 250b is generally fixed relative to the lower clamping member 218. Thus, upon pivotal movement of the intermediate clamping member 214 chances of slippage are reduced.

Modifications and improvements to the above-described embodiments of the present invention may become apparent to those skilled in the art. The foregoing description is intended to be exemplary rather than limiting. The scope of the present invention is therefore intended to be limited solely by the appended claims.

What is claimed is:

1. A pivoting assembly for connecting at least one support wheel assembly to a frame of a track system, the pivoting assembly comprising:
a first clamping member;
a first resilient member having a first engaging portion operationally engaged with the first clamping member, and a second engaging portion;
an intermediate clamping member having a first engaging side operationally engaged with the second engaging portion of the first resilient member, a second engaging side,
a shaft connected to the intermediate clamping member and configured to connect to at least one wheel,
a second resilient member having a third engaging portion and a fourth engaging portion, the third engaging portion being operationally engages with the second engaging side of the intermediate clamping member;
a second clamping member operationally engaged with the fourth engaging portion of the second resilient member and connected to the first clamping member,
wherein:
the intermediate clamping member being pivotable about a pivot axis,
the first clamping member and the intermediate clamping member spaced to apply a first clamping force to the first resilient member, and
the second clamping member and the intermediate clamping member are spaced to apply a second clamping force to the second resilient member.

2. The pivoting assembly of claim 1, wherein in response to the intermediate clamping member pivoting about the pivot axis, at least one of the first and second resilient members are configured to bias the intermediate clamping member toward a first position.

3. The pivoting assembly of claim 1, wherein:
in a first state, when the first and intermediate clamping members apply the first clamping force, and the intermediate and second clamping members apply the second clamping force, the first engaging side of the intermediate clamping member engages the second engaging portion with a first contact area, and the second engaging side of the intermediate clamping member engages the third engaging portion with a second contact area; and
in a second state:
the first and intermediate clamping members apply a third clamping force, the third clamping force being greater than the first clamping force,
the intermediate and second clamping members apply a fourth clamping force, the fourth clamping force being greater than the second clamping force,
the first engaging side of the intermediate clamping member engages the second engaging portion with a third contact area, and
the second engaging side of the intermediate clamping member engages the third engaging portion with a fourth contact area.

4. The pivoting assembly of claim 3, wherein the third contact area is greater than the first contact area and the fourth contact area is greater than the second contact area.

5. The pivoting assembly of claim 3, wherein:
the second contact area is configured to increase progressively in response to gradually increasing the first clamping force; and
the fourth contact area is configured to increase progressively in response to gradually increasing the second clamping force.

6. The pivoting assembly of claim 1, wherein:
the first clamping force pre-stresses the first resilient member; and
the second clamping force pre-stresses the second resilient member.

7. The pivoting assembly of claim 1, wherein:
at least one of the first, second, third and fourth engaging portions has a first inter-engageable member; and
a corresponding one of the first clamping member, the second clamping member, the first side of the intermediate clamping member and the second side of the intermediate clamping member of the at least one of the first, second, third and fourth engaging portions has a second inter-engageable member complementary to the first inter-engageable member, the first inter-engageable member being configured to provide a mechanical interlock.

8. The pivoting assembly of claim 1, wherein at least one of the first, second, third and fourth engaging portions defines one of: a generally flat profile, a generally convex profile, and a generally concave profile.

9. The pivoting assembly of claim 1, wherein at least one of:
a profile of a side extending between the first and second engaging portions of the first resilient member is generally concave; and
a profile of a side extending between the first and second engaging portions of the second resilient member is generally concave.

10. The pivoting assembly of claim 1, wherein the intermediate clamping member is pivotable about the pivot axis by about 15 degrees.

11. The pivoting assembly of claim 1, wherein the first resilient member is disposed vertically above the intermediate clamping member and the second resilient member is disposed vertically below the intermediate clamping member.

12. The pivoting assembly of claim 1, wherein the first and second resilient members are made of a polymeric material.

13. The pivoting assembly of claim 12, wherein the polymeric material is rubber.

14. The pivoting assembly of claim 1, wherein the first clamping member is member of a frame of the track system.

15. The pivoting assembly of claim 1, wherein at least one of :
the first resilient member is a first leading resilient member, and the pivoting assembly further includes a second trailing resilient member longitudinally spaced from the first leading resilient member; and
the second resilient member is a second leading resilient member, and the pivoting assembly further includes a second trailing resilient member longitudinally spaced from the second leading resilient member.

16. The pivoting assembly of claim 15, wherein the first and second leading resilient members are disposed longitudinally forward from the shaft, and the first and second trailing resilient members are disposed longitudinally rearward from the shaft.

17. The pivoting assembly of claim 1, wherein the second clamping member is removably connected to the first clamping member.

18. A track system comprising:
a frame assembly;
a sprocket wheel assembly operatively connected to the frame assembly;
at least one pivoting assembly of claim 1 removably connected to the frame assembly;
a plurality of support wheel assemblies connected to the frame assembly by the at least one pivoting assembly.

19. A pivoting assembly for a track system, the pivoting assembly being configured to connect to at least one wheel, the pivoting assembly comprising:
a first resilient member having a body which is resiliently compressible,
a first clamping member and an intermediate clamping member, the first and intermediate clamping members being configured to exert a first compressive force on the first resilient member;
a second resilient member having a body which is resiliently compressible;
a second clamping member, the second clamping member and the intermediate clamping member being configured to exert a second compressive force on the second resilient member;
a shaft member having end portions which are connectable to wheel assemblies of the track system and being moveable, about a pivot axis in response to a vertical displacement of the wheels,
the shaft member being connected to the intermediate clamping member such that responsive to movement of the shaft member, one or both of the first resilient member and the second resilient member are further deformed and exert a responsive force on the intermediate clamping member to counteract the movement of the shaft member.

20. The pivoting assembly of claim 19, wherein the shaft member extends generally transversely to the intermediate clamping member.
